(19) United States
(12) Patent Application Publication
(10) Pub. No.: US 2011/0311722 A1
(43) Pub. Date: Dec. 22, 2011

(54) Method of and system for forming nanostructures and nanotubes

(76) Inventor: Sadeg M. Faris, Pleasantville, NY (US)

(21) Appl. No.: 11/496,065

(22) Filed: Jul. 28, 2006

Related U.S. Application Data
(63) Continuation-in-part of application No. 10/582,605, filed on Jun. 9, 2006.
(60) Provisional application No. 60/669,029, filed on Apr. 7, 2005.
(60) Provisional application No. 60/699,619, filed on Jul. 15, 2005.

(51) Int. Cl. B05D 1/34; B05C 9/12; B82Y 40/00

(52) U.S. Cl. 427/203; 118/600; 977/842

(57) ABSTRACT

The present invention relates to a methods of and systems for forming nanostructures having precise dimensions and configurations. A structure is provided with lattice mismatch on a substrate or intermediate layer. Curling is self induced or induced by pressure and/or temperature to form precise nanostructures and nanotubes, in term of precise length and precise diameter, as well as of precise configuration.

### RELATED APPLICATIONS

This application is a Continuation in Part of U.S. Non-provisional application Ser. No. 10/582,605 filed on Jun. 9, 2006, which is a national phase filing under 35 USC 371 of PCT Application Serial No, US06/13681 filed on Apr. 7, 2006, entitled “Probes, Methods of Making Probes and Applications of Probes”, which claims priority to U.S. Provisional Application Nos. 60/669,029 filed on Apr. 7, 2005 entitled “DNA Sequencing Method and System” and 60/699,619 filed on Jul. 15, 2005 entitled “Molecular Analysis Probe, Systems and Methods, including DNA Sequencing”, and is related to U.S. Non-provisional Ser. No. 11/______, filed on the same date as the present application, under Express Mail Label Number EV443782141US (Attorney Docket Number REVEO-0260USAAPN39), entitled “Method Of and System For Cutting Carbon Based Materials”, and U.S. Non-provisional Ser. No. 11/______, filed on the same date as the present application, under Express Mail Label Number EV443782155US (Attorney Docket Number REVEO-0260USAAPN38), entitled “Material Comprising Predetermined Number of Atomic Layers and Method for Manufacturing Predetermined Number of Atomic Layers”, all of which are incorporated by reference herein.

### TECHNICAL FIELD

The present invention related to a method of and system for forming nanostructures and nanotubes

### BACKGROUND ART

Twenty-first century science and technology endeavors, research and development innovations that solve problems for man-kind will increasingly be dominated by the ability to make structures and objects that have sizes with length scales approaching those of atoms and molecules having dimensions of a nano-meter or less. Nano-scale matter and objects exhibit unique behaviors, some of which have yet to be revealed in addition to the known remarkable optical, thermal, electrical and mechanical properties. These open new vistas for many applications. For example, sequencing, imaging, nano-lithography, manipulation, nano-scale self assembly, nanometer scale chemistry, and many other applications with benefit from nano-scale technology development.

It is envisioned and believed that being involved in the nano-size frontier of science, technology and innovation is a sure path to regional and national economic well being, and competitiveness. This is evidenced by the extraordinary investment activities by big and small countries, large and small private sector enterprises and nearly unparalleled entrepreneurial activities.

To advance in the nano-scale frontier science and technology requires access to and mastering the following:
Tools to produce nano-objects
Tools to measure sizes with sub-Angstrom precision
Substrates that have atomic smoothness with minimum contamination
Tools to see (image) nano-objects and manipulate them, grabbing, moving, gluing, etc.
Nano funnels/nozzles/probes for dispensing substances and stimuli
Tools to accurately measure all physical properties such as thermal, electrical, and optical.

Key parameters become smaller by 10 to 20 orders of magnitude as compared to similar parameters in the macro-world. In the last 5 years the collective achievements of the best and brightest people around the world related to the above tools have grown at astonishing rates, delivering numerous discoveries, innovations, methods, products and tools.

Known techniques allow production of sub-micron objects and features that can be produced by means of conventional optical, UV, e-beam, X-ray and lithography. These tools are being extended to produce sizes below 30 nanometers. As they are stretched to produce even smaller sizes, their limitations become more and more apparent, in terms of cost, foot-print, etc. Indeed, at high electron and ion beam accelerating voltages >100 KV features smaller that 10 nm have been demonstrated. The preparation steps and the cost of the equipment and ancillary components make these prior art methods cumbersome and slow.

Various embodiments presented in parent application Ser. No. 10/582,605 (and related PCT Application Serial No, US06/13681), incorporated by reference herein, depart from use of convention lithography based photon, ion and e-beams to produce the smallest features. Instead, ultra-thin films are used in parent application Ser. No. 10/582,605 for this purpose thereby allowing one to produce similar or better results with faster ramp-up times and with more convenience.

There are many known methods of producing films with atomic precision. These include, deposition by sputtering, electron beam, ion beam, molecular beam epitaxy, CVD, MOCVD, plasma, laser deposition, pyrolitic deposition, electrochemical, thermal evaporation, sputtering, electro-deposition, molecular beam epitaxy, adsorption from solution, Langmuir-Blodgett (LB) technique, self-assembly and many other related methods collectively referred to as Thin Film Deposition Methods. Accurate metrology enables the production and control of thicknesses with Angstrom precision. Producing free standing films by peeling is possible as taught in U.S. Pat. No. 7,045,878 and U.S. patent application Ser. No. 10/970,814 filed on Oct. 21, 2004 and manipulation and formation of vertically integrated devices of such films taught in applicant's U.S. Pat. No. 7,033,910, U.S. patent application Ser. No. 11/406,848, U.S. Pat. No. 6,875,671, U.S. patent application Ser. No. 11/020,753, U.S. patent application Ser. No. 10/719,663, U.S. Pat. No. 6,956,268, and U.S. patent application Ser. No. 10/793,653, all of which are incorporated by reference herein.

The advent of scanning tunneling microscopy (STM), atomic force microscopy, AFM, scanning probe microscopy, SPM, and related tools have enabled the imaging of surfaces and structures with atomic resolution. This has opened new avenues to advance our understanding of many physical and chemical phenomena that are being exploited in numerous practical applications in the fields of medicine, nanotechnology, nano-electronics, genomics, proteomics, nano-electrochemistry, and destined to make even more contributions in other fields in the futures.

To achieve nano-scale resolution and nanofabrication accuracy, and to properly interpret physical and chemical phenomena, it is desirable and oftentimes necessary to use atomically flat, atomically smooth substrates over a large area, for instance in the range of several square microns to several square centimeters. To produce such substrates, conventional methods rely on unsophisticated and inaccurate techniques of attaching an adhesive tape to the surface of mica or graphite to peel the top most atomic layers to reveal a fresh atomically smooth surface of a piece of mica or graphite of size and thickness. In almost all situations the atomic surface is the desired result while the lateral shape or size or thickness is of little importance. Conventional techniques could not teach methods of producing, handling and manipulating samples having a single layer of graphite (also called graphene) or mica, for example, or a predetermined desired number of mono-atomic of mica or graphite layers.

Graphites are well known and are widely used materials. For example U.S. Pat. No. 6,538,892 exploits its good mechanical and anisotropic thermal properties for the construction of heat sinks. Graphites according to the description in U.S. Pat. No. 6,538,892, are made up of layer planes of hexagonal arrays or networks of carbon atoms. These layer planes of hexagonally arranged carbon atoms are substantially flat and are oriented or ordered so as to be substantially parallel and equidistant to one another, as shown in FIG. 1. The substantially flat, parallel equidistant sheets or layers of carbon atoms, 110, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional e.g. thermal and electrical conductivity and fluid diffusion.

Briefly, graphites may be characterized as laminated structures of carbon, that is, structures consisting of superposed layers of carbon atoms joined together by weak van der Waals forces 112. In considering the graphite structure, two axes or directions are usually noted, to wit, the “c” axis or direction and the “a” axes or directions. For simplicity, the “c” axis or direction may be considered as the direction perpendicular to the carbon layers. The “a” axis or directions may be considered as the directions parallel to the carbon layers or the directions perpendicular to the “c” direction. The graphites suitable for manufacturing flexible graphite sheets possess a very high degree of orientation.

The bonding forces holding the parallel layers of carbon atoms together are only weak van der Waals forces. In a process referred to as exfoliation of graphite, natural graphites can be treated so that the spacing 112, d, in FIG. 1A between the superposed carbon layers 110 can be appreciably opened up so as to provide a marked expansion of Nd, as in FIG. 1B, the direction perpendicular to the layers, that is, in the “c” direction, and thus forms an expanded graphite structure in which the laminar character of the carbon layers is substantially retained. It has been shown that N can be in the range of 100 to 1000 according to the treatment process. The graphite layers are referred to as graphene layers possess very high electrical and thermal conductivities exceeding those of copper, while retain high temperatures and exceedingly Young modulus.

Recently, Andrei Geim and colleagues of the University of Manchester isolated a single sheet of graphene and measured its remarkable properties which include conductivity 100 higher than copper and astonishing Quantum Hall Effect behavior. These and other results are described in January, 2006, Physics Today. These results could be made possible only after successful isolation of a single 1 Angstrom graphene layer, a feat that was not previously possible. Geim's team succeeded in isolating a single graphene layer by random, tedious and unpredictable method. According to the Physics Today Article:
“Their method is astonishingly simple: Use adhesive tape to peel off weakly bound layers from a graphite crystal and then gently rub those fresh layers against an oxidized silicon surface. The trick was to find the relatively rare monolayer flakes among the macroscopic shavings. Although the flakes are transparent under an optical microscope, the different thicknesses leave telltale interference patterns on the SiO₂, much like colored fringes on an oily puddle. The patterns told the researchers where to hunt for single monolayers using atomic force microscopy.”

The work confirmed that graphene is remarkable-stable, chemically inert, and crystalline under ambient conditions.”

In another approach, a team led by Walt A. de Heer of the Georgia Institute of Technology in Atlanta produced graphene by heating the surface of a wafer of silicon carbide so that the silicon atoms evaporated, leaving behind a few layers of carbon atoms that assembled into graphene. As taught therein, a thin-film graphitic layer is produced by annealing preselected crystal face of a crystal.

In still another approach, Stankovich et al. derived exfoliated graphene oxide and attempted to reduce the graphene oxide to graphene, as an additive to enhance conductivity of graphene-polymer composites. Graphite oxides were chemically modified by treating graphite oxide with organic isocyanates to reduce the hydrophilic character of graphene oxide sheets. These isocyanate-derivatized graphite oxides form stable dispersions in polar aprotic solvents (such as N,N-dimethylformamide (DMF)), consisting of completely exfoliated, functionalized individual graphene oxide sheets with thickness 1 nm. These dispersions of isocyanate-derivatized graphite oxide allow graphene oxide sheets to be intimately mixed with many organic polymers to form graphene-polymer composites.

From the above and other recent investigations on graphene as well as from commercial supplier of graphite substrate, one concludes that there remains a need for inventing convenient, low cost, and fast methods for isolating single layers of graphene and predictable stacks of selected number of graphene layers. There further remains a need for methods for isolating single layer or predictable number of layers from lamellar or multilayer materials in general.

In addition to methods for isolating single layer or predictable number of layers from lamellar or multilayer materials in general, there remains a need to accurately form layers of graphene or other carbon based materials into virtually any desired shape to fit the application, for example, as a nanotool or component of a nanotool.

Conventional approaches to shaping and cutting on a nanoscale level, particularly cutting ultra thin (e.g., single atomic layer) are limited. Conventional cutting techniques, for example, those based on laser cutting, water jet, mechanical cutting tools, plasma cutting, or chemical etching exist, but have limitations as to the ability to control the cut depth in a convenient manner.

U.S. Pat. No. 6,869,581 to Kishi et al. teaches “cutting” a carbon nanotube by globurization of a deposited metal after pretreatment including heating the deposited metal close to its melting point in an oxygen atmosphere to induce oxidation.

With the advent of nanoscale materials and tools, a need exists for a suitable method to cut or define features of atomic layers of material, such as layers of graphene. However, using conventional approaches, it is not possible to cut to a selected depth (e.g., cut only one layer or to a selected depth of a multilayer structure). Furthermore, to minimize or avoid the need for post-cutting processing operations, for example, to remove defects and the like, cutting operations should not be detrimental to the material characteristics.

Very desirable materials for nano-scaled applications are based on carbon. Carbon nano-scaled materials have extraordinary strength, flexibility, and thermal conductivity, as well as many desirable electronic characteristics.^{1,2,3} Depending on the specific arrangement of its constituent atoms, a carbon nanotube can be a conductor or semiconductor, e.g., in the form of a miniature wire, diode, or transistor. Some types of nanotubes generate orders of magnitude less heat than comparable copper wires when a current is passed through them. With all of these useful electrical and mechanical properties, nanotubes also have only one-sixth the density of steel. ¹ S. Iijima, Nature (London), vol. 354, p. 56 (1991).² C. T. White, et. al.; Phys. Rev. B. vol. 47, p. 5485 (1993).³ J. W. G. Wildoer, et. al.; Nature (London), vol. 391, p. 59 (1998).

If properly assembled, nanotubes could have diverse technological applications, including more efficient flat-panel displays⁴ and longer lasting batteries. Smaller electronic components made from nanotubes could increase computer speed and memory capacity far beyond current levels.^{5,6} Miniaturization with nanotubes could also lead to unprecedented medical technologies,⁷ such as probes and repair devices that could be injected into the bloodstream to diagnose and treat patients. ⁴ S. S. Fan, et. al.; Science, vol. 283, p. 512 (1999).⁵ Y. Huang, et. al.; Science, vol. 294. p. 1313 (2001).⁶ A. Bachtold, et. al.; Science. Vol. 294, p. 1317 (2001).⁷ Y. Maeda, et. al.; Jpn. J. Appl. Phys. Vol. 40, p. 1425 (2001).

Various methods are known for growing carbon nano-scaled material. Since their properties strongly depend on their physical dimensions and alignments, attempts have been made to form these tubes into various configurations. The first report of an electric field effect on carbon nanotube alignment is plasma-induced alignment by Bower, et. al.⁸, where uniform films of aligned carbon nanotubes are described using microwave plasma-enhanced chemical vapor deposition (CVD). It has also been shown that the carbon nanotubes can be grown on contoured surfaces and aligned in a direction perpendicular to the local substrate surfaces. ⁸ C. Bower, et. al.; Appl. Phys. Lett., vol. 77, p. 830 (2000).

Further, Avigal, et. al., teaches aligned carbon nanotubes growth via a biased voltage during growth.⁹ Alignment of carbon nanotubes has been confirmed under a positive bias, not under negative bias or without an electric field. Other teachings of electric field directed growth of carbon nanotubes include Dai et al. teaching electric-field-directed growth of aligned single walled carbon nanotubes between elevated electrodes and catalysts.¹⁰ This technology has been applied to build carbon nanotubes based electronic devices.¹¹ ⁹ Y. Avigal, et. al.; Appl. Phys. Lett., vol. 78, p. 2291 (2001).¹⁰ Y. G. Zhang, et. al.; Appl. Phys. Lett., vol. 79, p. 3155 (2001).¹¹ N. R. Franklin, et. al.; Appl. Phys. Lett., vol. 81, p. 913 (2002).

Notwithstanding the developments to date in the field of carbon nanotubes, there remains a need for improved methods and systems for forming nanotubes of precise dimensions, in terms of length and diameter. Further, there remains a need for improved methods and systems for forming nanotubes of predetermined numbers of walls. Still further, there remains a need for methods and systems for forming nanotubes having heterogeneous composition.

### OBJECTS AND BRIEF SUMMARY OF THE INVENTION

Embodiments of the present invention described herein teach new methods, devices and tools that advances the nanotechnology art listed above. By departing from methods of prior art and adding new techniques departing form the teaching of the prior art, embodiments of the present invention provide the ability to make free standing nano-thickness atomically smooth films, including single or multiple layers from layered or lamellar materials including but not limited to such as mica, WS2, super lattices, MoS2, YBCO (yttrium barium copper oxide) and other related superconductors, NbSe2, Bi2Sr2CaCu2Ox, graphite, boron nitride, dichalcogenide, trichalcogenide, tetrachalcogenide, pentachalcogenide, double hydroxides, anionic clays and hydrotalcite-like materials. These single or multiple layers can be used as substrates and/or components for nanotools, and as starting materials for use to create unique composite materials of many different types of compositions and configurations.

Accordingly, certain objects herein are to produce single or predetermined numbers of known mono-atomic layers of graphene, mica and other layered or lamellar materials such as WS2, super lattices, MoS2, YBCO (yttrium barium copper oxide) and other related superconductors, NbSe2, Bi2Sr2CaCu2Ox, graphite, boron nitride, dichalcogenide, trichalcogenide, tetrachalcogenide, pentachalcogenide, double hydroxides, anionic clays and hydrotalcite-like materials, conveniently and inexpensively. Another object of this aspect of the invention to separate or exfoliate single mono-atomic layers from layered or lamellar materials including but not limited to layers of graphene and other lamellar or layered material derivative, and attaching them to substrate through a releasable bond.

In one aspect of the present invention, a material comprising a predetermined number of one or more layers is provided. The one or more layers are layers of a lamellar material that are weakly bonded to each other. In contrast to conventional processing of lamellar materials such as graphite, where random numbers of graphene layers are attempted to be derived from graphite, in the material according to aspects of the present invention, predetermined numbers of layers are provided.

In another aspect of the present invention, the predetermined number of layers are at least partially supported by a substrate.

In another aspect of the present invention, the predetermined number of layers are permanently attached to at least a portion of a substrate.

In another aspect of the present invention, the predetermined number of layers are removably attached to least a portion of a substrate.

In another aspect of the present invention, the at least one layer is an atomic layer of carbon atoms.

In another aspect of the present invention, the layer is a layer of graphene.

In another aspect of the present invention, at least a portion of a surface of said material is atomically flat.

In another aspect of the present invention, the at least one predetermined number of layers comprises a plurality a layers, wherein said plurality of layers is exfoliated.

In another aspect of the present invention, a composite material is provided including the material comprising a plural predetermined number of one or more layers and at least one introduced atomic or molecular species. In certain embodiments, the introduced atomic or molecular species is present at predefined depths between one or more of said plural layers. In certain other embodiments, the introduced atomic or molecular species is present at random depths between one or more of said plural layers. In certain further embodiments, the introduced atomic or molecular species is present at predefined areas of said material.

In another aspect of the present invention, a composite material is provided including the material comprising a predetermined number of one or more layers at least one layer of another material.

In another aspect of the present invention, a composite material is provided including a predetermined number layers of a first material layered with a predetermined number layers of a second material. In certain embodiments, the composite material further includes at least one introduced atomic or molecular species. In certain other embodiments, the introduced atomic or molecular species is present at random depths between one or more of said plural layers. In certain further embodiments, the introduced atomic or molecular species is present at predefined areas of said material.

In further aspects of the present invention, methods are provided for forming a predetermined number of layers of a lamellar material.

In one aspect of the present invention, a method of deriving a predetermined number of layers of a lamellar material includes permanently or removably attaching a substrate to a surface of a lamellar material having a plurality of layers that are weakly bonded to each other and applying a mechanical force at an edge between adjacent or non-adjacent layers with a tool having a knife edge configuration and a suitable tip edge thickness (e.g., sharpness).

In another aspect of the present invention, a method of deriving a predetermined number of layers of a lamellar material includes permanently or removably attaching a substrate to a surface of a lamellar material having a plurality of layers that are weakly bonded to each other, and applying a mechanical force between terminal ends with a tool having a knife edge configuration and a suitable tip edge thickness (e.g., sharpness). In further embodiments of this method, a mechanical force is also applied between terminal ends at another location of the layers with a tool having a knife edge configuration a suitable tip edge thickness (e.g., sharpness).

In another aspect of the present invention, a method of deriving a predetermined number of layers of a lamellar material includes permanently or removably attaching a substrate to a surface of a lamellar material having a plurality of layers that are weakly bonded to each other. The lamellar material is provided with a first layer having a first terminal end with an exposed face facing in a first direction and a second layer having a first terminal end in step configuration with the first terminal end of the first layer. Additionally, the first layer further including a second terminal end and the second layer further including a second terminal end with an exposed face, the first terminal ends being in a step configuration. A mechanical force is applied toward the exposed face of the second layer in a direction generally opposite the substrate thereby lifting off the predetermined number of layers. In certain other embodiments of this method, a mechanical force is also applied toward the exposed face of said first layer in a direction generally toward the substrate, so as to provide a “twits” lift-off action.

In another aspect of the present invention, a method of deriving a predetermined number of layers of a lamellar material includes applying a current between an electrode on or within a substrate attached to a lamellar material and a selected layer of the lamellar material, so as to create separation force whereby the interlayer forces between the selected layer and an adjacent layer proximate are decreased. In a further embodiment of this method, interlayer forces between the selected layer and the adjacent layer are decreased sufficiently to cause physical separation. In still further embodiments of this method, a mechanical force is also applied to pull one or more predetermined number of layers.

In another aspect of the present invention, a method of deriving a predetermined number of layers of a lamellar material includes applying a voltage between one or more electrode on or within a substrate attached to the lamellar materials and a selected layer; so as to create a separation force whereby the interlayer forces between the selected layer and an adjacent are decreased. In a further embodiment of this method, interlayer forces between the selected layer and the adjacent layer are decreased sufficiently to cause physical separation. In still further embodiments of this method, a mechanical force is also applied to pull one or more predetermined number of layers.

In another aspect of the present invention, a method of deriving a predetermined number of layers of a lamellar material includes permanently or removably attaching a first substrate to a first surface of a lamellar material having a plurality of layers that are weakly bonded to each other, the first substrate attached with an attachment force greater than the interlayer forces of the lamellar material. A second substrate is also permanently or removably attaching a second substrate to a second surface of the lamellar material. The first substrate is lifted to separate one or more layers of the lamellar material from other layer or layers of the lamellar material attached to the second substrate. This process may be repeated until a predetermined number of atomic layers is derived.

In another embodiment of the present invention, methods of and systems for cutting a carbon based material is provided using electrochemical cutting techniques. For example, carbon based materials having one or more superposed layers of carbon atoms being joined together substantially by van der Waals forces are particularly suited as workpieces for the herein methods of and systems for cutting a carbon based material. Other carbon based materials are also suited as workpieces for the herein methods of and systems for cutting a carbon based material.

In general, a method of cutting a carbon based material includes applying localized electrical energy or electromagnetic energy at a cut line with a cutting tool. Particularly, when the application of energy occurs in an environment containing oxygen, carbon atoms are locally oxidized at the cut line such that carbon dioxide gas forms at the cut line, thereby removing carbon atoms of said material at said cut line. In one aspect, the cutting tool includes an oxidation catalyst at a cutting tip of said cutting tool. In another aspect, an oxidation catalyst is included at the cut line of the layer to be cut. In a further aspect, the cutting tool may be operably coupled to a motion control sub-system. In another aspect, the carbon based material to be cut is supported on a motion control sub-system.

In further embodiments, the cutting tool may be configured for cutting around a portion to be removed, and a handler is provided that is removably or permanently attached to the portion to be removed.

In another embodiment of the present invention, a cutting tool is provided for cutting a carbon based material. The tool includes a cutting tip configured and dimensioned to form a cut line in one or more superposed layers of carbon atoms in an oxygen environment. A cutting system is also provided including the cutting tool operably coupled to a motion control sub-system, or a plurality of cutting tools, which may be operably coupled to a motion control sub-system.

In another embodiment, a system includes the cutting tool and a handler removably or permanently attached to the portion to be removed. In still further embodiments, the handler is provided for applying an upward delaminating force to one or more layers at the region of the portion to be cut away from the material, and a structure is also provided for applying a downward force outside of the region of the portion to be cut.

In other embodiments of the present invention, methods of and systems for forming nanostructures having precise dimensions and configurations. A nano structure, for example, cut to a desired shape using the herein described cutting methods, is provided with lattice mismatch on a substrate or intermediate layer. Curling is self induced or induced by pressure and/or temperature to form precise nanostructures and nanotubes, in term of precise length and precise diameter, as well as of precise configuration.

### BRIEF DESCRIPTION OF THE FIGURES

The foregoing summary as well as the following detailed description of preferred embodiments of the invention will be better understood when read in conjunction with the appended drawings. For the purpose of illustrating the various embodiments and aspects of the invention, there is shown in the drawings embodiments which are presently preferred. It should be understood, however, that the invention is not limited to the precise arrangements and instrumentalities shown in the drawings, where:

FIG. 1A shows a representation of a lamellar or multilayer material such as graphite;

FIG. 1B shows a representation of a lamellar or multilayer material such as graphite whereby spacing between layers are expanded;

FIG. 2A shows one embodiment of a method step according to the present invention to selectively peel off a single layer from a lamellar material—

FIGS. 2B-2C show one embodiment of a system and method according to the present invention to selectively peel off a single layer from a lamellar material;

FIGS. 2D-2F show another embodiment of a system and method according to the present invention to selectively peel off a single layer from a lamellar material;

FIGS. 3A-3C show another embodiment of a system and method according to the present invention to selectively peel off a single layer from a lamellar material;

FIGS. 4A-4B show another embodiment of a system and method according to the present invention to selectively peel off a single layer from a lamellar material;

FIGS. 5A-5B show another embodiment of a system and method according to the present invention to selectively peel off a single layer from a lamellar material;

FIGS. 6A-6C show another embodiment of a system and method according to the present invention to selectively peel off a single layer from a lamellar material;

FIG. 7 shows a heterogeneous lamellar structure including a predetermined numbers of atomic layers of various types of material;

FIGS. 8A-8C show various embodiments of a predetermined numbers of atomic layers having material incorporate between certain layers thereof and at various locations;

FIGS. 9A-9C show\ a single layer, three layers and any number N layers of the lamellar material that may be derived according to certain aspects to the present invention;

FIGS. 10A-10B show an overview and a detailed view, respectively, of an embodiment of an electrochemical cutting tool according to certain embodiments of the present invention;

FIG. 11A shows a system including a cutting tool configured for cutting a hole or line in one or more layers and controlled with motion control functionality;

FIG. 11B shows a system including an array of cutting tools to cut one or more layers from a material;

FIGS. 12A-12J show many different shapes may be created using the electrochemical cutting tool of certain embodiments of the present invention

FIGS. 13A-13D, it is shown that one or more layers may be formed into plates having precise patterns formed therein using the ECT according to certain embodiments of the present invention upon one or more layers, for example, derived from a lamellar material.

FIG. 14A-14C4 show a system and method for cutting and removing a portion of a layer from a lamellar structure;

FIG. 15A shows an electrochemical cutting tool according to certain aspects of the present invention for cutting through a plurality of layers of a lamellar material;

FIG. 15B shows various shapes of an electrochemical cutting tool according to certain aspects of the present invention;

FIG. 16 shows formation of stacks of cut portions according to certain aspects of the present invention;

FIG. 17 shows a structure of component including precisely formed channels that may be formed according to certain aspects of the present invention;

FIG. 18 shows various exemplary patterns or lines that may be formed on a layer according to certain aspects of the present invention;

FIGS. 19A-19C show a system for and method of creating a shape or shaped region in a layer according to certain aspects of the present invention;

FIGS. 20A-20D show various exemplary nanotools that may be formed according to certain aspects of the present invention; and

FIGS. 21A-21C show a method to form precision nanotubes according to certain aspects of the present invention; and

FIGS. 22A-22B show a method to form precision nanotubes having one or more coaxial tubes therein according to certain embodiments of the present invention.

### DETAILED DESCRIPTION OF THE FIGURES

Certain aspects of the present invention provides convenient, low cost, and fast methods for isolating single layers of graphene and predictable stacks of selected number of graphene layers. Methods for isolating single layer or predictable number of layers from lamellar or multilayer materials are also provided by certain aspects of the present invention. Lamellar or multilayer materials that may be used to isolate a single layer or a predictable number of layers include but are not limited to mica, WS2, super lattices, MoS2, YBCO (yttrium barium copper oxide) and other related superconductors, NbSe2, Bi2Sr2CaCu2Ox, graphite, boron nitride, dichalcogenide, trichalcogenide, tetrachalcogenide, pentachalcogenide, double hydroxides, anionic clays and hydrotalcite-like materials.

Therefore, many aspects of the present invention involve production of single and a predetermined number of multiple layers of lamellar material. Many of the inventive features and certain embodiments of the present invention rely on the ability to make ultra-thin, nano-scale films. In further embodiments, it is desirable that these films are atomically flat films. These enable the fabrication of all the probe configurations that perform a variety of functions necessary to advance the frontier of nano-science and technology including but not limited to imaging, analysis, sequencing, nano-lithography, and nano-manipulation as well a variety of other applications. Thin film deposition methods describe above may be used to produce thing films with Angstrom precision. Alternatively, even more precisely define thickness can be produced the controlled peeling of one or more predetermined number of layers from lamellar material as taught herein. These embodiments described herein apply to lamellar or multilayer materials, including but not limited to graphite to produce graphene layers, layers of mica, MoS2 and other lamellar or multilayer materials.

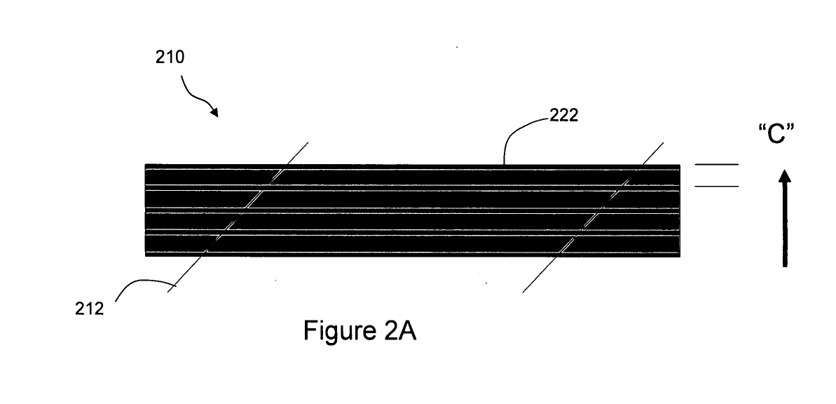

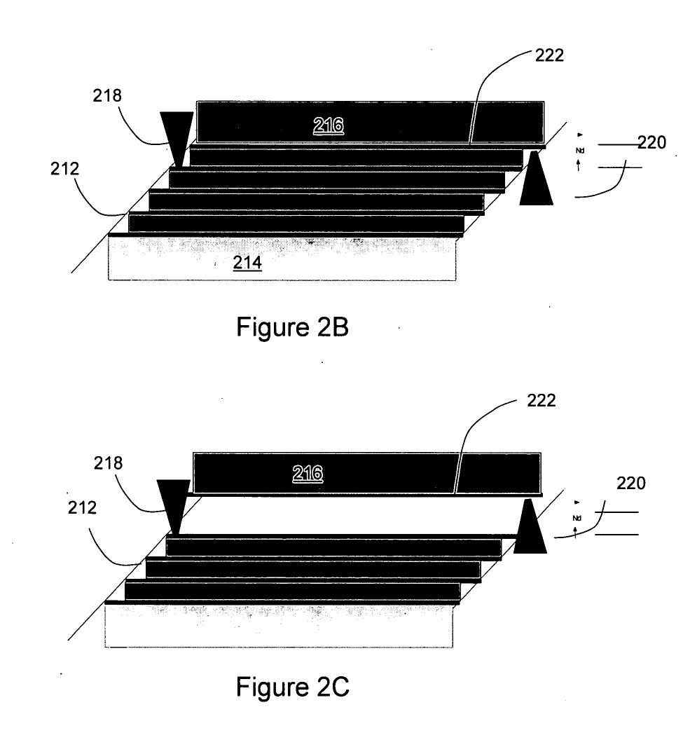

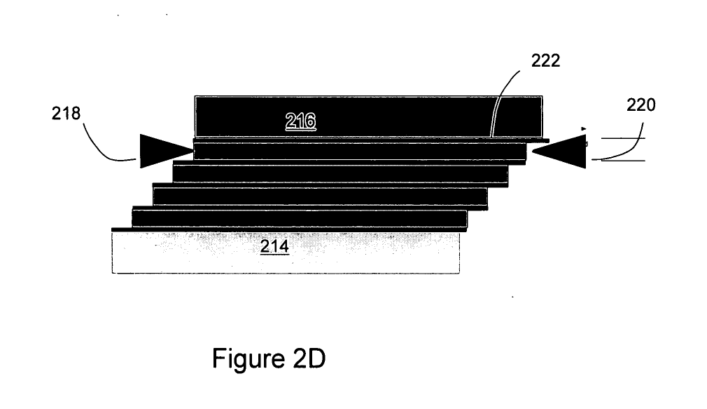

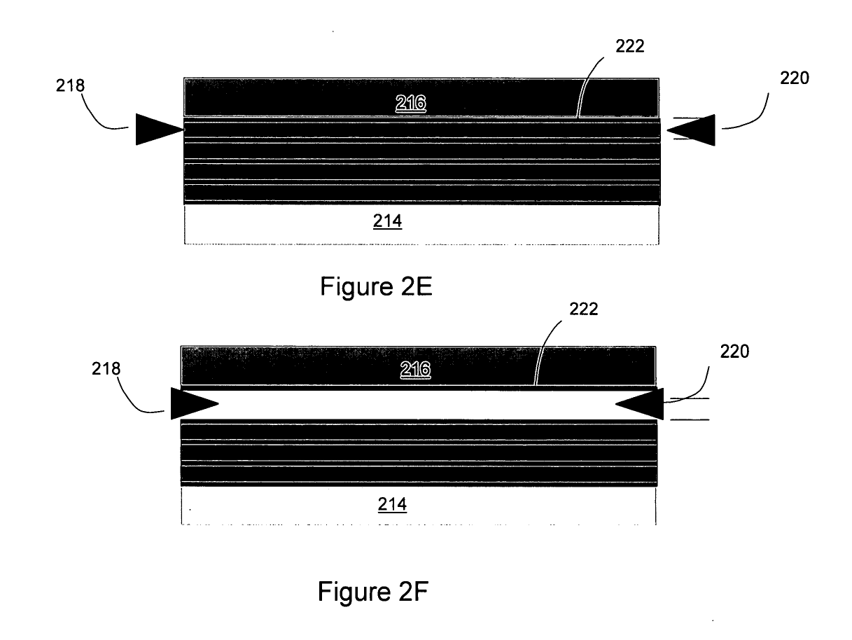

One embodiment to selectively peel off a single layer from a lamellar material, 210, is illustrated in FIG. 2A. The material is cut along the line 212, at an angle of, for example, 20 degrees or more relative the “c” axis. Such an angled cut allows access to the top most layer 222, as each layer is sequentially removed according to FIG. 2B. Two knife edge probes, as described in parent application Ser. No. 10/582,605 (and related PCT Application Serial No, US06/13681), incorporated by reference herein, for example, having tip opening dimensions small enough to access individual layers or groups of layers that are revealed due to the angular cut, are use to facilitate the peeling process. Knife edge probe 218 pushes down on the second layer (which is supported on other layers and/or a first substrate 214) while knife edge probe 220, pushes up the first layer against a second substrate 216, attached to the desirable first layer. The substrate 216 may be permanently bonded or removably bonded to the first layer 222 Removable bonding may be accomplished by various bonding and handling techniques including but not limited to adhesives, waxes, and vacuum handlers. FIG. 2C shows the complete separation of the first layer that is attached to the substrate 216 which is being pulled vertically to facilitate the separation process.

In another embodiment, knife edges 218, 220, are applied in the horizontal directions pushing on both sides pry loose the first layer while the substrate 216 is pulling upward. The substrate 216 may be permanently bonded or removably bonded to the first layer 222. Removable bonding may be accomplished by various bonding and handling techniques including but not limited to adhesives, waxes, and vacuum handlers.

This methods illustrated in FIG. 2A-F, may be facilitated with knowledge of separation characteristics between layers, for example, with known imaging techniques such as AFM and STM. This information, along with well know tools to move the knife edges with sub-angstrom precision, allows for reliable separation of a predetermined number of desired layers, or a single layer.

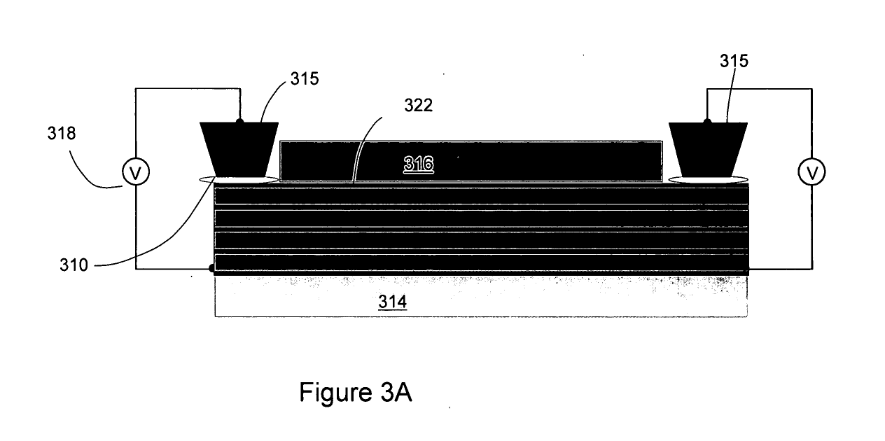

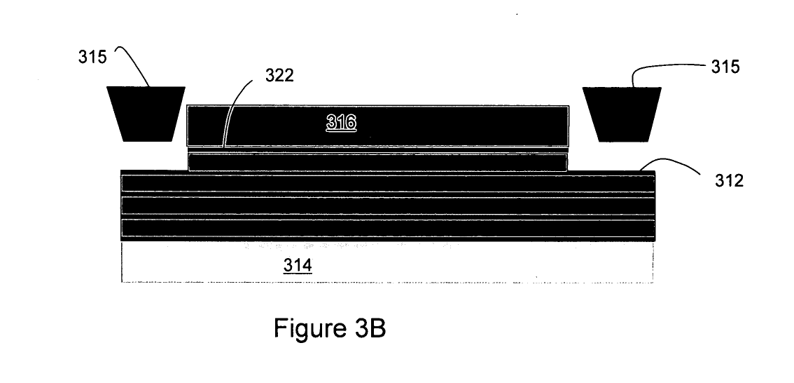

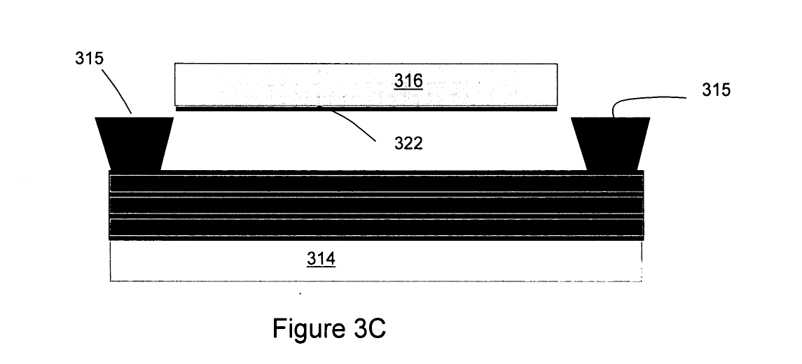

FIG. 3A-C illustrates yet another embodiment to reliably separate a predetermined number of desired layers, or a single layer. It exploits etching the peripheral regions of the first layer 310 to expose the second layer by known etching techniques including electrochemical etching, as shown in FIG. 3A. Note that one may etch to expose a third, fourth, or N^{th} layer thereby allowing for removal of a selected predetermined number of layers, for example, in combination with methods described in FIG. 2A-F above to allow for the selection and the removal of more than a single layer. Further, a voltage source 318 may be applied across electrodes 315, that are contacting the peripheral regions 310, of the first layer 322, to electrochemically etch the desired surface. Alternatively, other etching techniques such as chemical etching and sputter etching may be employed.

After the etching is complete, the exposed second layer 312 is pushed as in FIG. 3B, whereby the electrodes 315 (or another mechanical structure) push down on the second layer and subsequent layers optionally against a substrate 314 while the top substrate 316 permanently or removably bonded to the first layer 322 is pulled upward. Thus a single layer (or a predetermined number of layers) may be conveniently and inexpensively removed and optionally transferred to a third substrate.

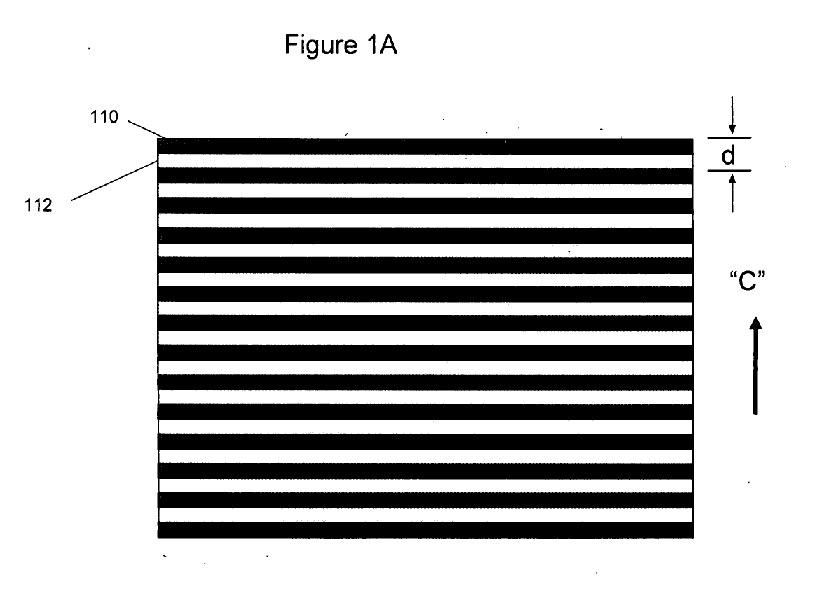

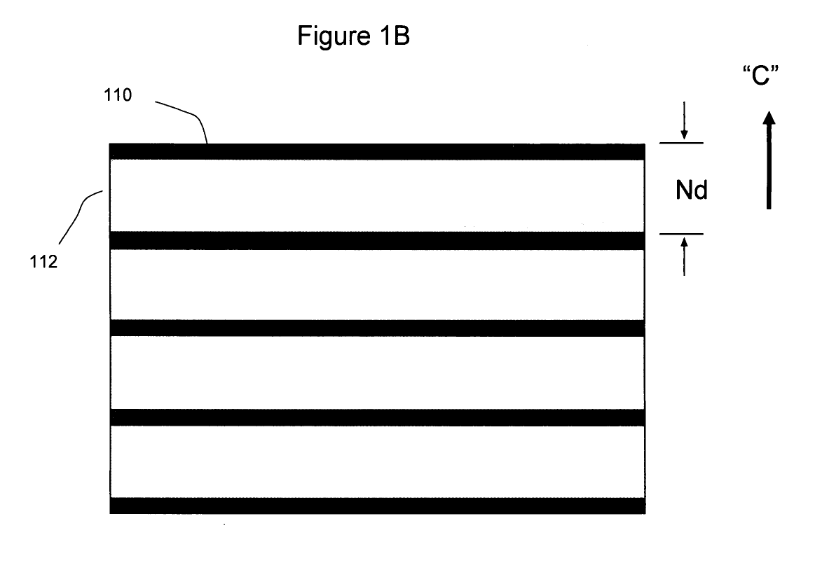

The substrate 316 is removably bonded to the first layer 322 by many bonding and handling techniques including but not limited to adhesives, waxes, and vacuum handlers. The final result in 3C may be repeated for all the other layers of the lamellar material until all layers are removed with minimum of waste. This method can also be combined with method described in FIG. 2A-F above to allow for the selection and the removal of more than a single layer. For instance, in the case of graphene, it may be desirable to have a single layer of 1 Angstrom, 2 layers of 2 Angstroms or, N layers of multiple Angstroms, depending on how the graphite is exfoliated to swell the interlayer spacing by factors of 10-1,000. (See exfoliated graphite description presented above with respect to FIGS. 1A and 1B).

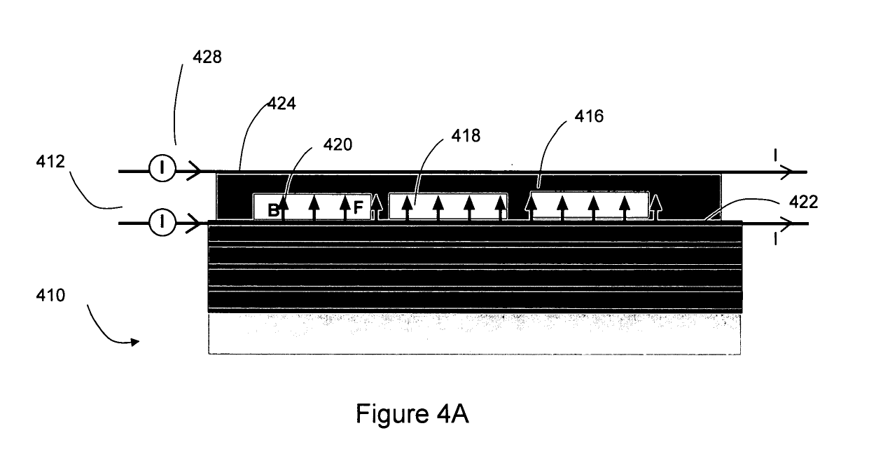

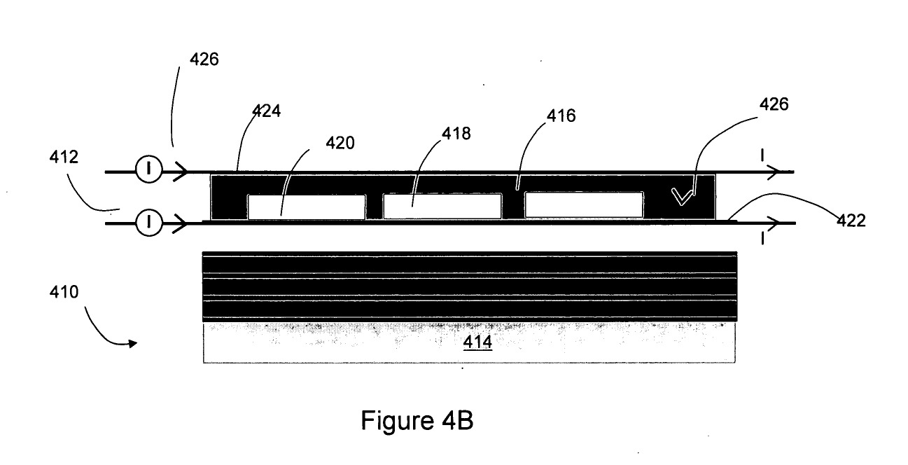

Another embodiment that takes advantage of the unique properties of graphene and other metallically coated lamellar materials is described in FIG. 4A-B. A special substrate 416 is provided and is removable attached to the first layer 422 intended for removal. Current 428 from a current source 412 is applied to the first graphene layer 422 and electrode 424 deposited on top of substrate 416. The current 428 flowing in electrode 424 and flowing out (in the opposite direction) of single layer 422 result in a magnetic force 420 that selectively pulls upward in the upward direction 418 the first layer 422. This advantageously utilizes the natural electrically conductive nature of lamellar materials such as graphene, that is, wherein the material exhibits a higher electrically conductivity along the surface or planar direction thereof as compared to across the thickness of lamellar materials. By further applying a mechanical force upward to substrate 416, the combination of magnetic and mechanical forces allows peeling with ease of layer 422. Since no such forces are influencing second and third layers, they are left intact. The separation process is illustrated in FIGS. 4A-B. Furthermore, in combination with various other techniques described herein, the method and system of FIGS. 4A and 4B may be employed to enhance the separation, or reduce the interlayer bond strength, to allow removal of a predetermined number of layers of lamellar material.

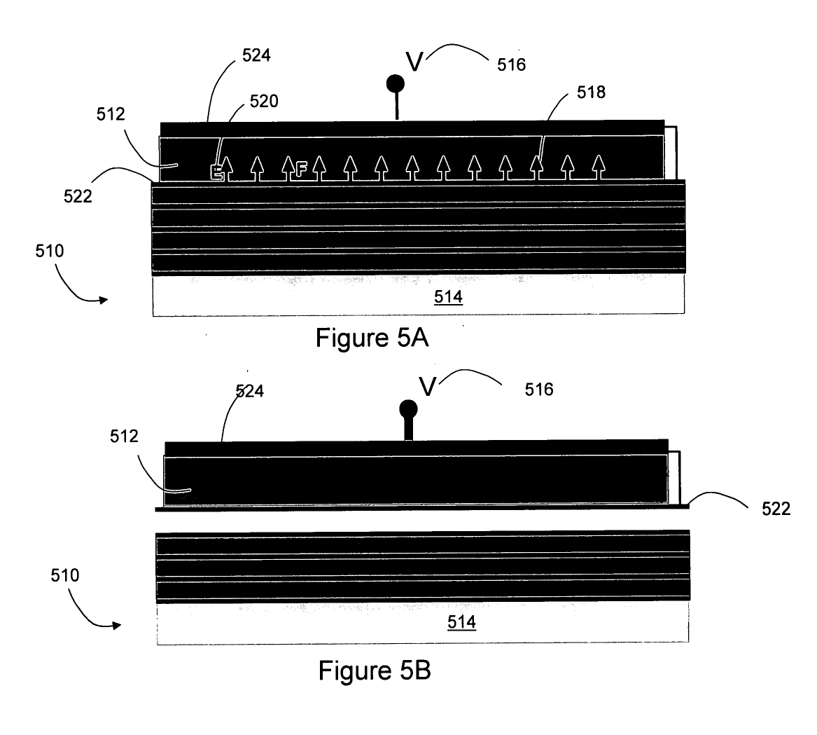

Instead of exploiting the magnetic force in the aforementioned embodiment, it is possible to use instead electrostatic force as illustrated in FIGS. 5A-B. In this case a voltage source 516 is applied to electrode 524, deposited on substrate 512 and a revealed portion of the first layer 522. The electric field 520 is applied and causes an electrostatic force in the upward direction 518, and along with a mechanical force applied to a substrate upward in a pulling selection, the first layer is selectively removed from the entire multi layer structure 510. Furthermore, in combination with various other techniques described herein, the method and system of FIGS. 5A and 5B may be employed to enhance the separation, or reduce the interlayer bond strength, to allow removal of a predetermined number of layers of lamellar material.

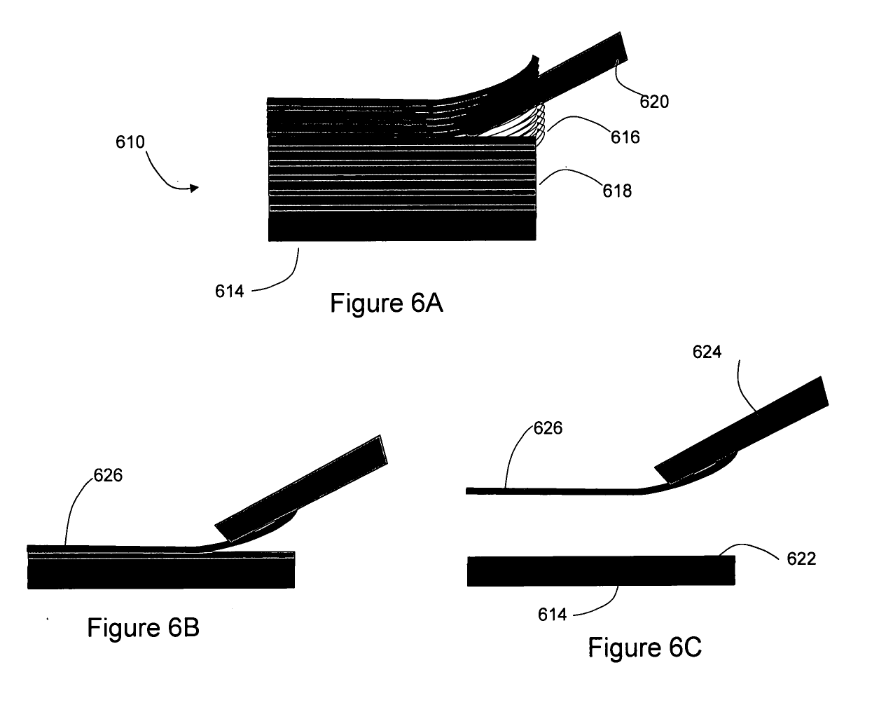

Another embodiment of peeling layers of lamellar material is shown in FIGS. 6A-C. Here the multilayer lamellar structure 610 is attached to a substrate 614 to the bottom while at the top implement substrate 612 is removably attached to the top of the specimen. Said substrate 612 may be a vacuum handler, adhesive tapes or other films with removable adhesives. The first step is to lift substrate 612 which will pull or peel a random number of layers 616, shown in FIG. 6A. This process is repeated as necessary until the last few layers remain as in FIG. 6B. In FIG. 6C the second to last layer is finally removed, leaving the last layer 622 bonded to substrate 614. Note that the shavings, or the peelings of random number of layers are in turn attached to substrate 614 and the process is repeated until the desired number of single layers are removed and utilized.

The above embodiments of methods to selectively remove single layers, or predetermined number of layers from lamellar could be combined as appropriate to achieve most advantageous, practical and economical way to produce the desired results.

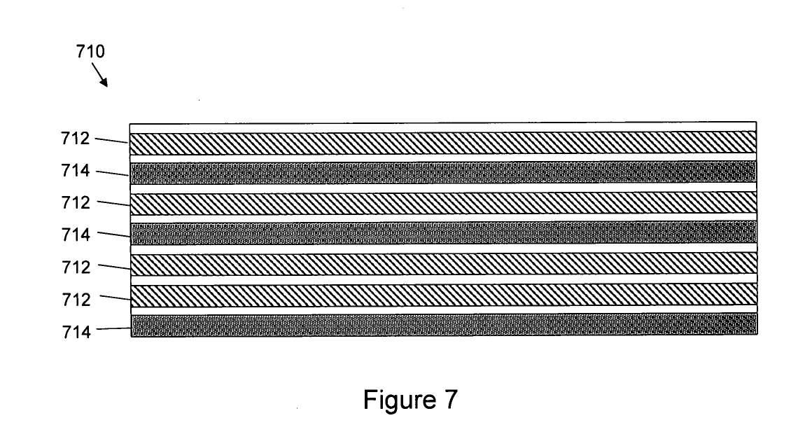

Referring now to FIG. 7, it is shown that by controlling the number of atomic layers, it is possible to stack predetermined numbers of atomic layers of various types of material to provide a heterogeneous lamellar structure. For example, a composite material 710 may be provided with certain layers of a first material 712 and certain layers of a second material 714. Note that one of the materials is one or more atomic layers derived from a lamellar material as described herein, and the other material may comprise, for example, another one or more atomic layers derived from a lamellar material as described herein, or other material including but not limited to one or more materials selected from the group consisting of insulating materials, semiconductor materials, oxides, superconductors, metals, magnetic materials, hydrides, GdMg, WO3, MoO3, LiCoO2.

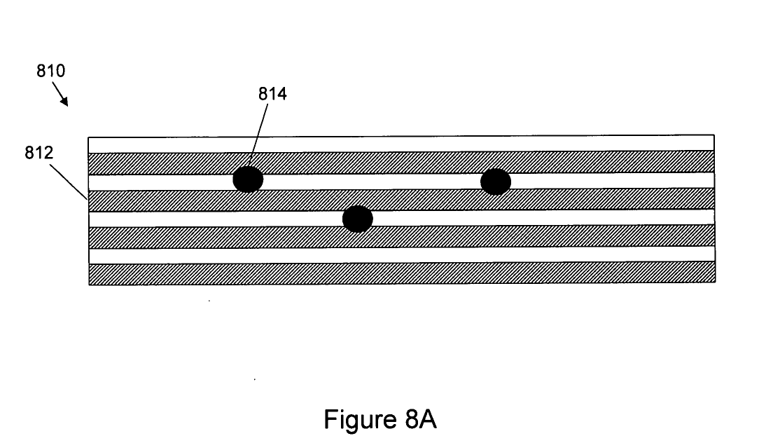

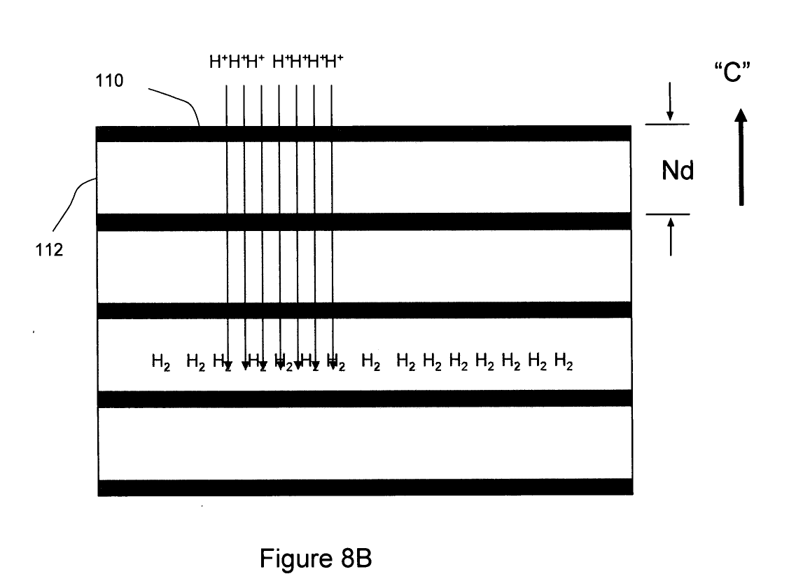

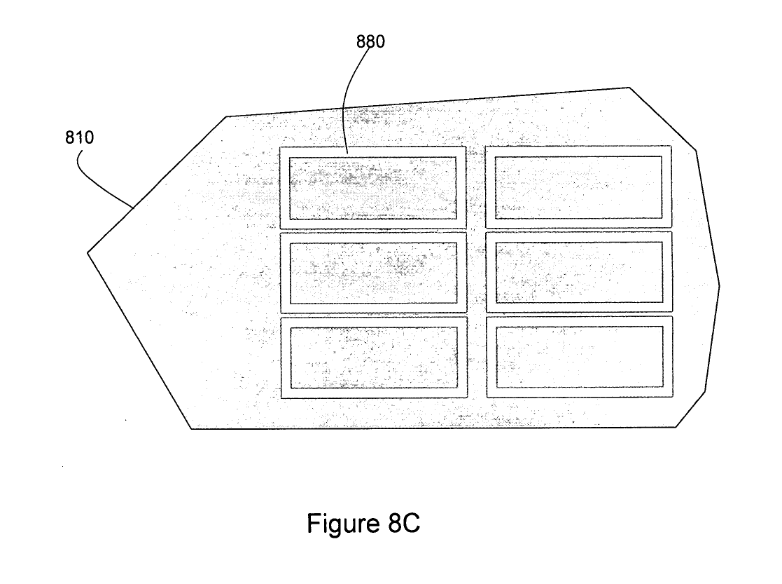

Referring now to FIG. 8A, it is shown that by controlling the number of atomic layers, it is possible to stack predetermined numbers of atomic layers and incorporate between certain layers various types of material to provide a composite structure 810 including the predetermined number of atomic layers 812 and the incorporated material 814. The incorporated material 814 may be introduced by various implantation techniques, including but not limited to implantation techniques wherein particles and/or ions of the incorporated material 814 are accelerated or otherwise imparted with direct force to penetrate certain layers 812. Further, the incorporated material 814 may be introduced by various intercalation techniques, including but not limited to intercalation techniques so that the incorporated material 814 is inserted or interposed, for example, wherein the predetermined number of atomic layers 812 is disposed in a gas or liquid medium including material 814 is provided as a species mixed therein.

Referring to FIG. 8B, it is shown that the penetration depth of the implanted ions or other species may be tailored to various needs. For example, the energy level may differ depending on the desired depth, e.g., 50 eV to 100 eV to penetrate the 1st layer, 100 eV to 200 eV to penetrate the second layer, and so on.

In certain preferred embodiments, a narrow energy distribution is selected to achieve a narrow depth penetration or intercalation distribution species. This allows selection of a consistent depth, or number of layers penetrated. Note that smaller energy doses may be required for embodiments of the present invention whereby graphene one of plural layers as compared to traditional semi-conductor material implantation methods. Since the van Der Walls forces between layers are very weak, smaller dosages (in terms of current and/or voltage) is required. In certain other embodiments of the present invention, a broad energy distribution, e.g., ranging from about 50 V to about 10 kV, is selected to selected to allow penetration intercalation of species over a number of layers. For example, such a composite, having penetrated catalytic species therethrough, may serve as an oxidation catalyst (including, for example, H⁺, Cs⁺, Li⁺, Na⁺, K⁺) for various cutting embodiments as described in co-pending application Ser. No. 11/______, filed on the same date hereof, under Express Mail Label Number ______, entitled “Method Of and System For Cutting Carbon Based Materials”, which is incorporated by reference, and also further herein. This penetration or intercalation further may take place starting from designated areas of an exposed surface of the lamellar material, thereby allowing for specific areas of a planar surface to be implanted, as shown in FIG. 8C, wherein the predetermined number of layers 810 (or a composite as described with respect to FIG. 7, 8A, or 8B) have areas 880 (shown as thick white lines in the shape of rectangles with untreated regions in the interior of the rectangle) with material introduced therein, for example, as catalytic species to facilitate cutting as described in aforementioned co-pending application Ser. No. 11/______, filed on the same date hereof, under Express Mail Label Number ______, entitled “Method Of and System For Cutting Carbon Based Materials”, and also further herein.

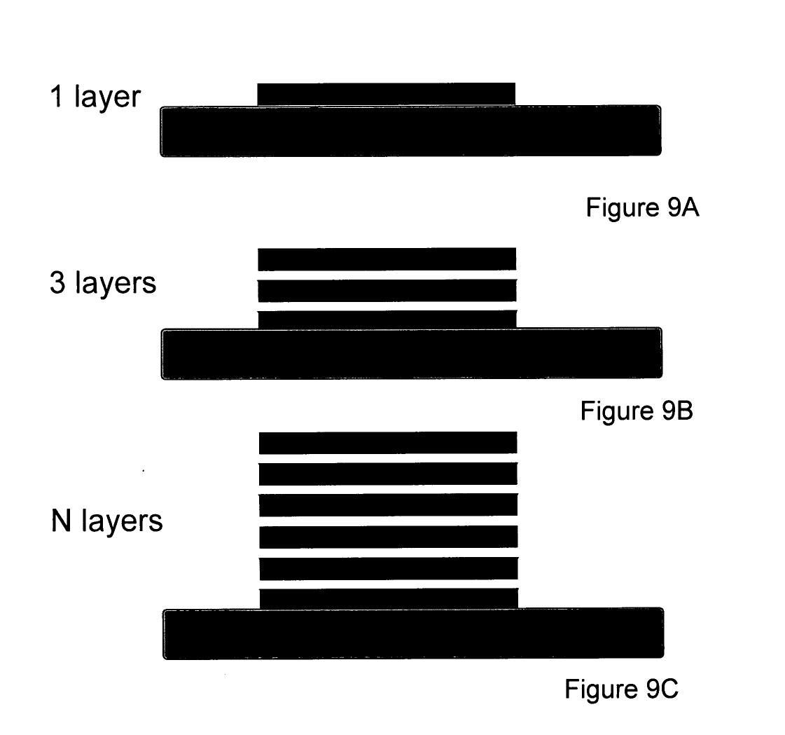

Referring now to FIGS. 9A-9C, it is shown that using the herein described methods, it is possible to isolate one layer (FIG. 9A), three layers (FIG. 9B), or any number N layers (FIG. 9C) of the lamellar material.

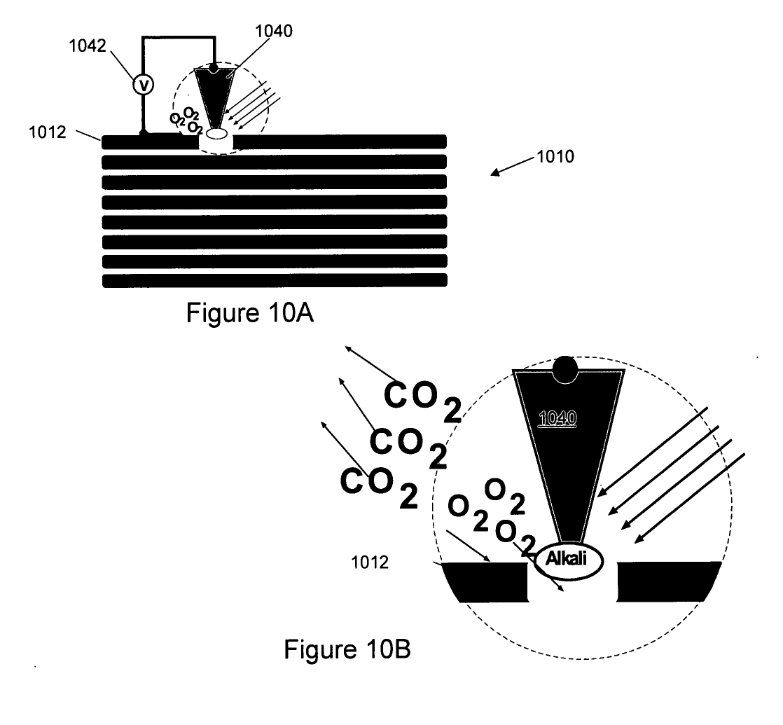

Referring to FIGS. 10A and 10B, an overview and a detailed view, respectively, of one embodiment of an electrochemical cutting tool according to certain embodiments of the present invention is shown. A stack of layers 1012, such as a lamellar material 1010, is provided. In general, an electrochemical cutting tool (ECT) 1040 according to certain aspects of the present invention is used to cut through one or more layers 1012 as shown using electrochemical reaction. Alternatively, the material to be cut may comprise another form of carbon, such as carbon nanotubes or carbon nanocoils.

When the layer 1012 is a layer of a material that oxidizes into a gas or a material that may be selectively removed from the non-oxidized portions, cutting is facilitated. In particular, when the lamellar material 1010 comprises a carbon based material such as graphite, layers of graphene (random numbers), one layer (e.g. graphene, formed as described above), predetermined numbers of layers (e.g. graphene, formed as described above), such that each layer 1012 is a layer of carbon based material such as a layer of graphene, when oxidized by the ECT 1040, the oxide, CO2, is expelled and cutting is facilitated. When electrical or electromagnetic energy is applied through the ECT 1040, e.g., with an energy source 1042, in an oxygen environment material from one or more layers 1012 having cut edges may be removed from the stack, or alternatively, a pattern may be cut into one or more layers 1012. The energy source 1042 may comprise a voltage source, a current source, or an electromagnetic energy source. In a preferred embodiment, the energy source 1042 includes a voltage source that is attached to the layer to be cut, to close the loop and allow for an electron flow path, optimizing the voltage application at the desired cut line of the tool 1040.

A suitable cutting tool 1040 that cuts using oxidation may be formed of materials including but not limited to Pt, Ni, Au, Pd, or other material plated with catalysts for oxidation. The dimensions of the tip of the tool (i.e., that generally is related to the thickness of the cut kerf) may be on the order of millimeters, micrometers, nanometers, or sub-nanometer. For example, as described in above referenced U.S. patent application Ser. No. 11/400,730, various methods of fabricating sub-nanometer probes are detailed. In certain embodiments, the tool includes a coating or an attached group at the tip to serve as a catalyst For example, alkali metals may be used to catalyze oxidation. In certain additional embodiments, the cutting operation may occur in an ozone enriched environment, whereby oxidation is promoted.

Notably, in certain embodiments, herein, processes and systems using the ECT 1040 advantageously takes advantage of the natural directional thermal and electrically conductive properties of lamellar material such as graphene, that is, wherein the material exhibits a higher thermal and electrically conductivity along the surface or planar direction of lamellar materials thereof as compared to across the thickness of lamellar materials. When energy is applied at a particular location of a surface of a layer, heat and energy is conducted along the planar direction of the surface of the material, or along the planar direction of the layer being cut when that layer has most of its surface unexposed (e.g., when a hole accesses a layer within a lamellar material and exposes a surface of a layer, which layer is the layer being cut or otherwise acted upon by the ECT 1040). This allows precise control of the depth of cutting, for example, by controlling the energy application (e.g., electrical or electromagnetic energy).

Further, since the oxide of carbon is a gas at preferred operating temperatures, unlike other materials, cutting is facilitated. During the cutting process, cut material at the kerf region (the thickness of the cut, or the cutting tip, of the ECT 1040) is removed due to their gaseous properties. This is in contrast to oxidation of other metals, where the oxide is solid and requires further processing to cut the oxide away from the as material being cut.

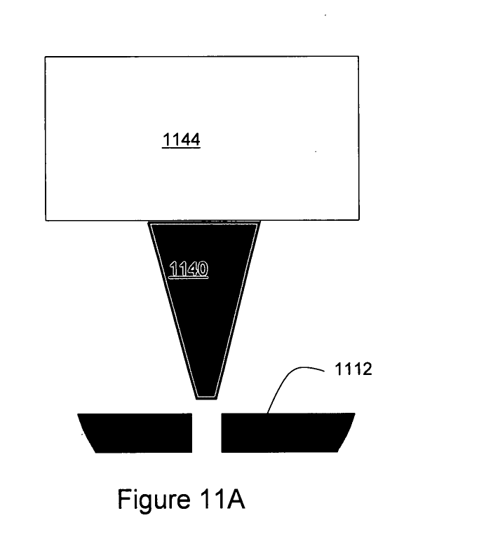

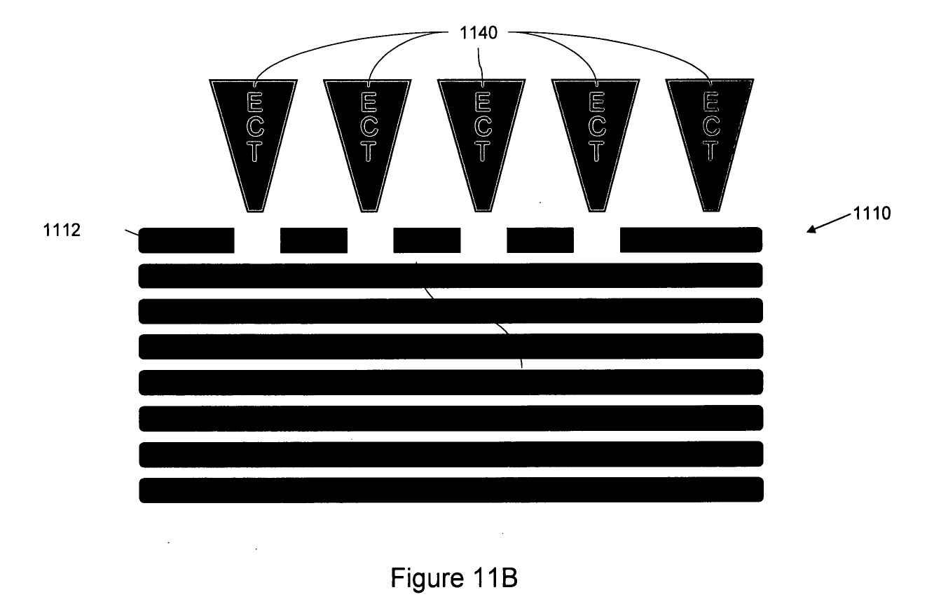

Referring now to FIG. 11A, a system is show including a cutting tool 1140 configured for cutting a hole or line in one or more layers 1112 and controlled with a motion control sub-system 1144. The motion control sub-system 1144 may comprise an X-Y, an X-Y-Z, or any other suitable motion control system. As described in above referenced U.S. patent application Ser. No. 11/400,730, motion control may be precise to the sub-angstrom level.

Referring now to FIG. 11B, it is shown that an array of cutting tools 1140 may be provided to cut one or more layers 1112 from material 1110. Note that these cutting tools 1140 may be provided in an X-Y, an X-Y-Z, or any other suitable motion control system. Further, these cutting tools 1140 may be independently connected to motion control sub-systems for independent motion of the plural cutting tools 1140, or be grouped and moved in unison.

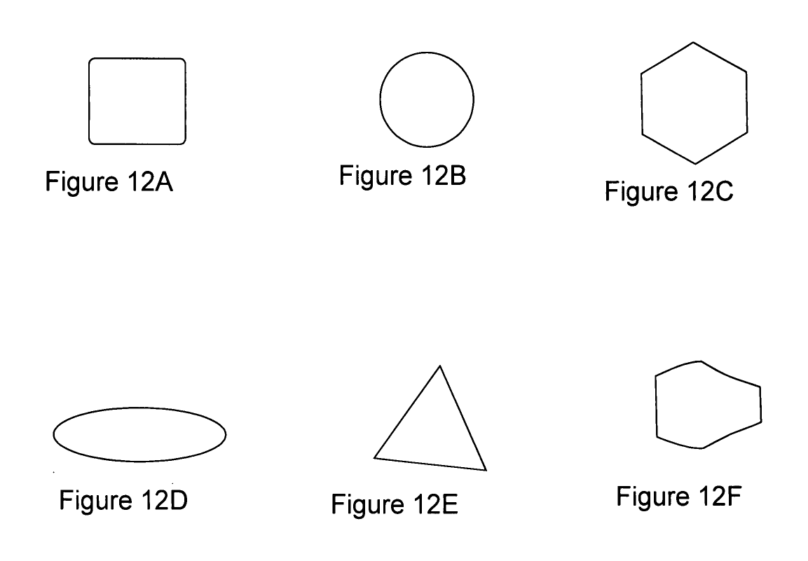

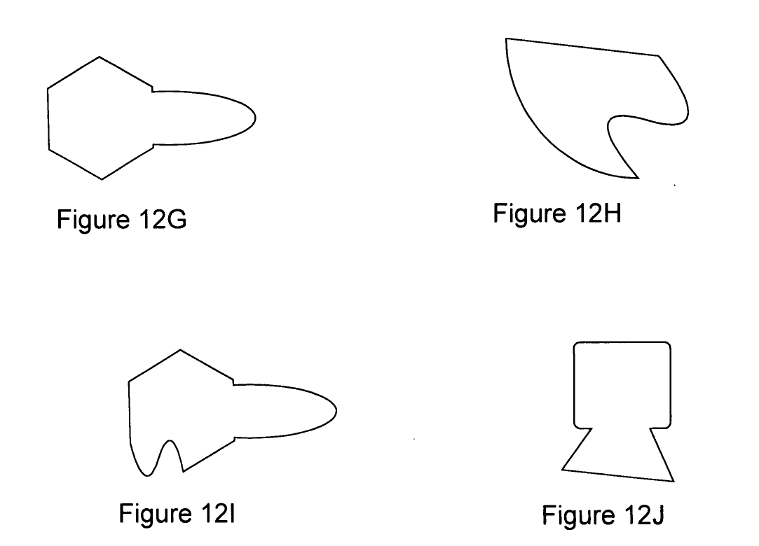

For example, referring now to FIGS. 12A-12J, it is shown that many different shapes may be created using the ECT of certain embodiments of the present invention. These different shapes may be used in many different applications. For example, these shapes may be used for authentication and anti-counterfeiting such as described in applicants U.S. Pat. No. 6,643,001 which is incorporated by reference herein. Further, the shapes formed to precise sizes and any shape may be used in various MEMs, nano-electro-mechanical, microfluidic and nano-fluidic devices, micro- and nano-optical devices, micro- and nano-electronic devices, and the like as described in U.S. Pat. No. 7,045,878, U.S. patent application Ser. No. 10/970,814 filed on Oct. 21, 2004, U.S. Pat. No. 7,033,910, U.S. patent application Ser. No. 11/406,848, U.S. Pat. No. 6,875,671, U.S. patent application Ser. No. 11/020,753, U.S. patent application Ser. No. 10/719,663, U.S. Pat. No. 6,956,268, and U.S. patent application Ser. No. 10/793,653, all of which are incorporated by reference herein.

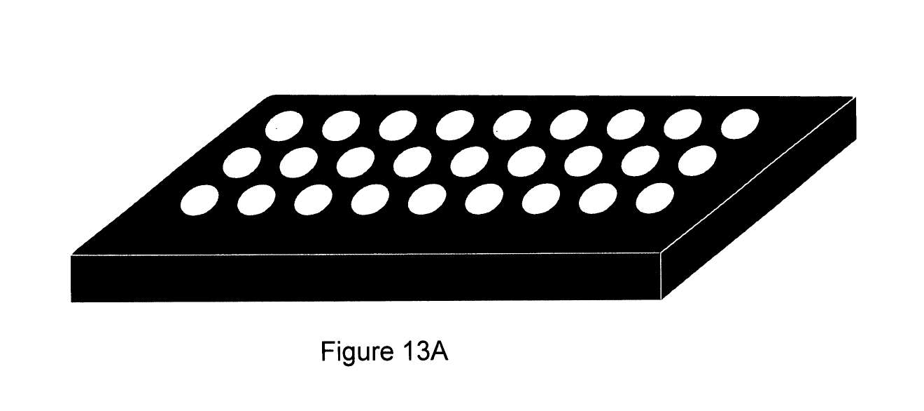

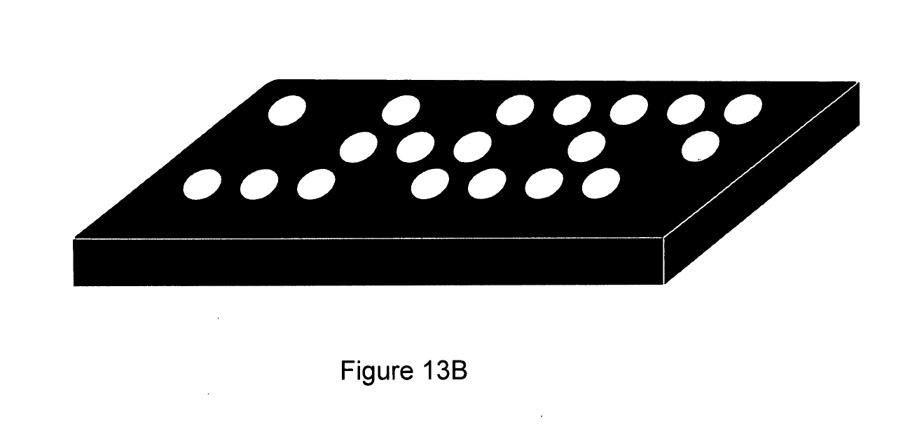

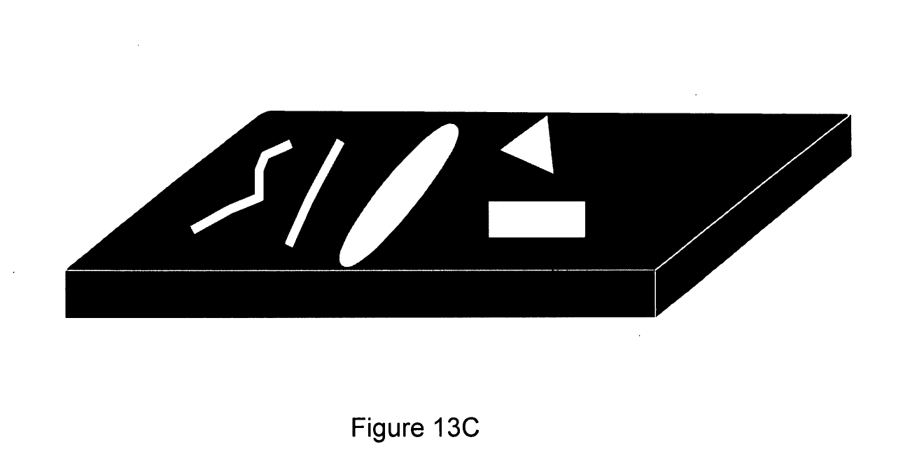

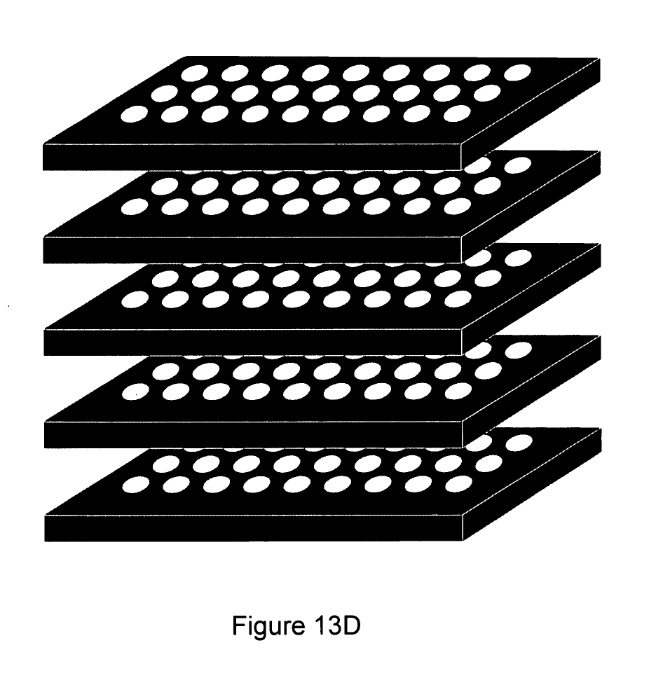

Further, and referring now to FIG. 13A-13D, it is shown that one or more layers may be formed into plates having precise patterns formed therein using the ECT according to certain embodiments of the present invention upon one or more layers, for example, derived from a lamellar material.

FIG. 13A shows, for example, a mask having a nano-shadow pattern for depositing material there through or exposing light or electromagnetic energy or radiation there through.

FIG. 13B shows, for example, a layer having a nano-pattern that may be used as high density mass storage media. In certain embodiments, materials are selected for forming this nano-patterned layer that can withstand extreme temperatures, for example, up to 2000 C, for extremely reliable and virtually indestructable storage.

FIG. 13C shows, for example, a layer having a nano-pattern that may be used as nano-printing plate for replicating analog or digital data. Accordingly, using the structure of FIG. 13C, one may create a nano-scale printer or copier.

FIG. 13D shows a plurality of layers having nano-openings formed therein that may be used as or as components within structures including but not limited to micro- or nano-fluidic devices, molecular sieves, gas diffusion electrodes, reverse osmosis membranes, supercapacitor electrodes, oxygen generator electrodes, or other structures that may benefit from small controlled dimension openings or pores.

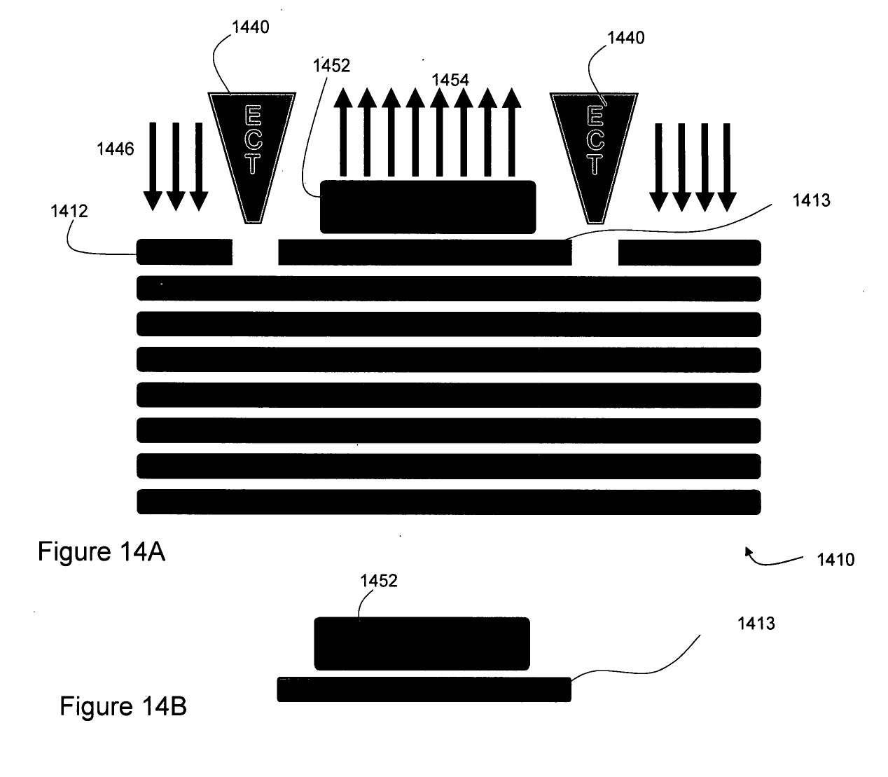

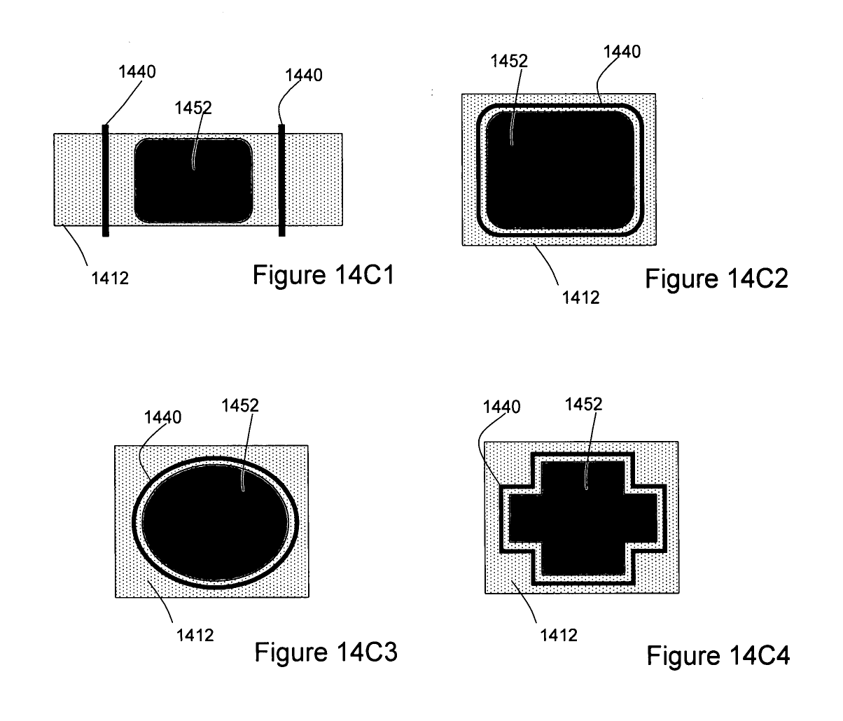

Referring now to FIG. 14A, a system is shown for cutting and removing a portion 1413 of a layer 1412 from a lamellar structure, including a cutting tool 1440 configured for cutting around the portion 1413 to be removed and a handler 1452 attached to the portion 1413 to be removed. It is shown that by applying a downward force 1446 outside of the portion 1413 to be removed and an upward delaminting force 1454 via the handler 1452, the portion 1413 may be removed. The portion 1413 is shown removed from the lamellar structure 1410 in FIG. 14B. The handler 1452 may be permanently attached, e.g., whereby it is used as a substrate for the portion 1413. Alternatively, it may be removably attached, e.g., with a removable adhesive, or using vacuum pressure, for example, as described in applicants co-pending U.S. patent application Ser. No. 10/017,186 filed on Dec. 7, 2001 entitled “Device And Method For Handling Fragile Objects, And Manufacturing Method Thereof”, which is incorporated by reference herein.

Referring now to FIGS. 14C1-14C4, it is shown that the portion 1413 may be removed using an ECT 1440 and corresponding handler 1452 of various shapes.

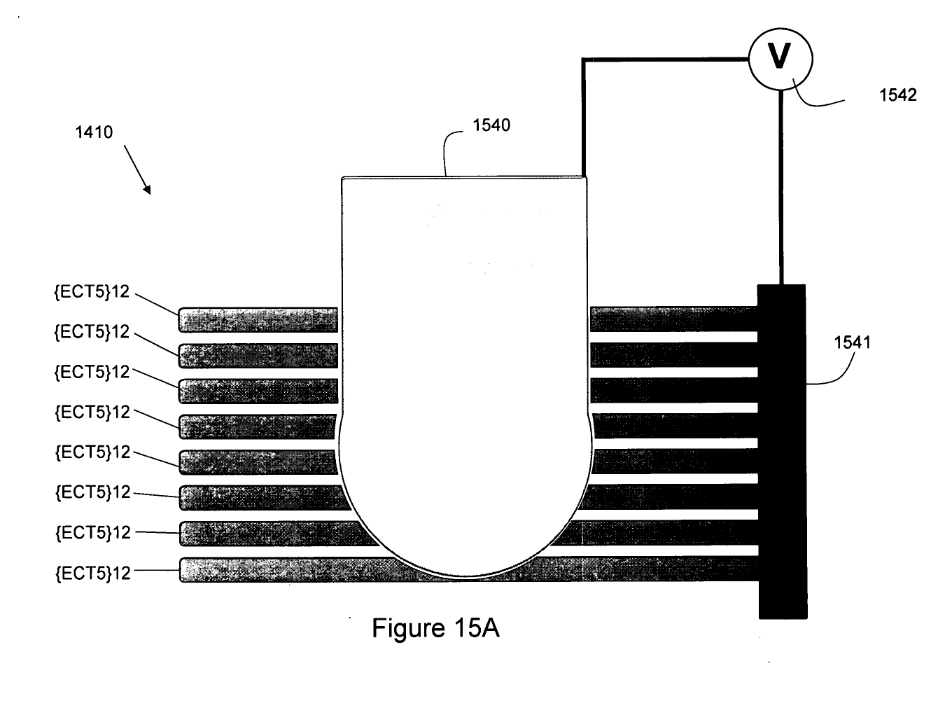

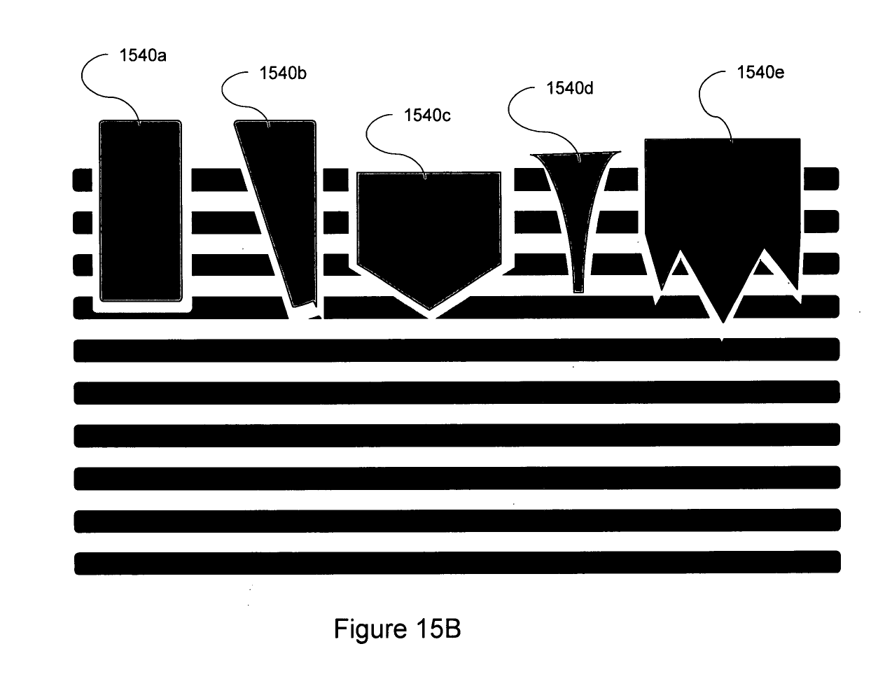

Referring now to FIG. 15A, it is shown that an ECT 1540 may be used to cut through a plurality of layers 1512 of a lamellar material 1510. For example, a conductor 1541 may be applied to an edge of plural layers 1512. When the energy source 1542 is activated, and the ECT 1540 is applied to a layer, the current flow path will be closed allowing for electrochemical oxidation. Note that until ECT 1540 contacts a second or other layer 1512 deeper within the lamellar material 1510, there will be little or no current flow since the conductivity across the thickness of the layer and between layers is very low compared to the conductivity in the direction of the surface of the layer.

Referring now to FIG. 15B, it is shown that an ECT may be provided in a variety of shapes 1540a, 1540b, 1540c, 1540d and 1540e, for example, may be used to cut through a plurality of layers 1512 of a lamellar material 1510. In this manner, many three dimensional shapes and three dimensional nanostructures may be formed.

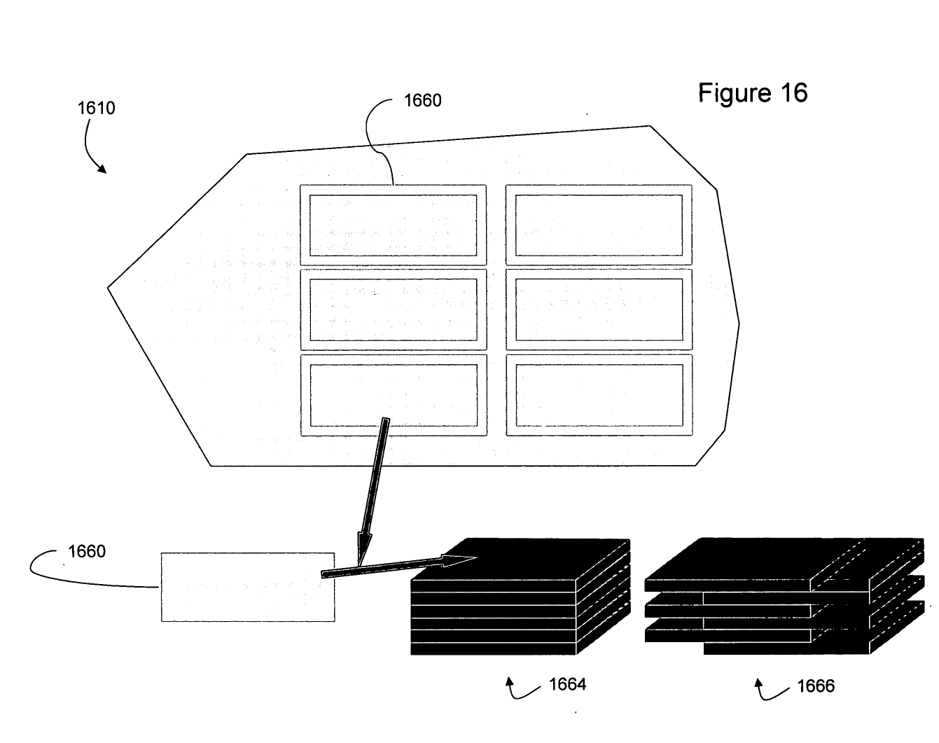

Referring now to FIG. 16, it is shown that multiple sections 1660 may be derived from a layer 1610. In particular, as shown in FIG. 16, plural standard shapes 1660, or any desired shape, may be cut from a layer 1610 of generally irregular shape. These extracted shapes 1660 may be used alone, for example in probes as described in U.S. patent application Ser. No. 11/400,730, stacked into a stack 1664 or an offset stack 1666, or processed with suitable electronic features, electro-mechanical features, opto-mechanical features, or the like, and stacked into a stack 1664 or an offset stack 1666.

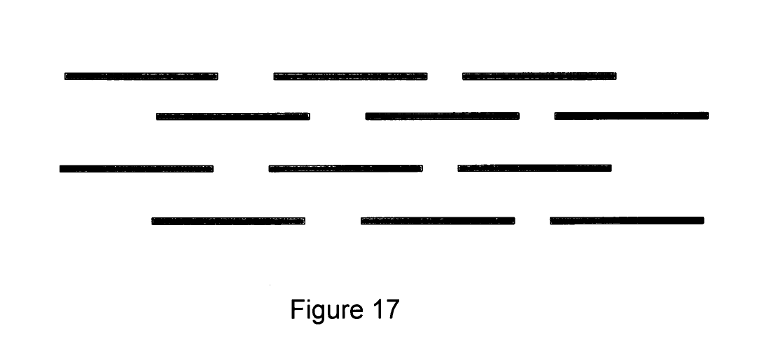

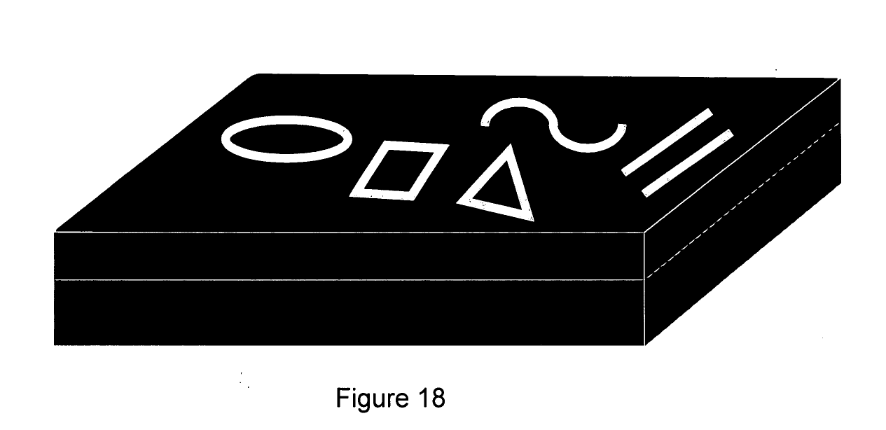

Referring now to FIG. 17, it is shown that using precisely cut sections of ultra thin layers, e.g., of graphene, precise channels may be formed for use, e.g., that may be used as or as components within structures including but not limited to micro- or nano-fluidic devices, molecular sieves, gas diffusion electrodes, reverse osmosis membranes, supercapacitor electrodes, oxygen generator electrodes, or other structures that may benefit from small controlled dimension openings or pores. Referring now to FIG. 18, it is shown that using the ECT described herein, patterns may be “chiseled” out of a layer or a plurality of layers. This may be useful, for example, as a stamping pattern, a memory device, as a mask, or as a micro- or nano-fluidic component or device.

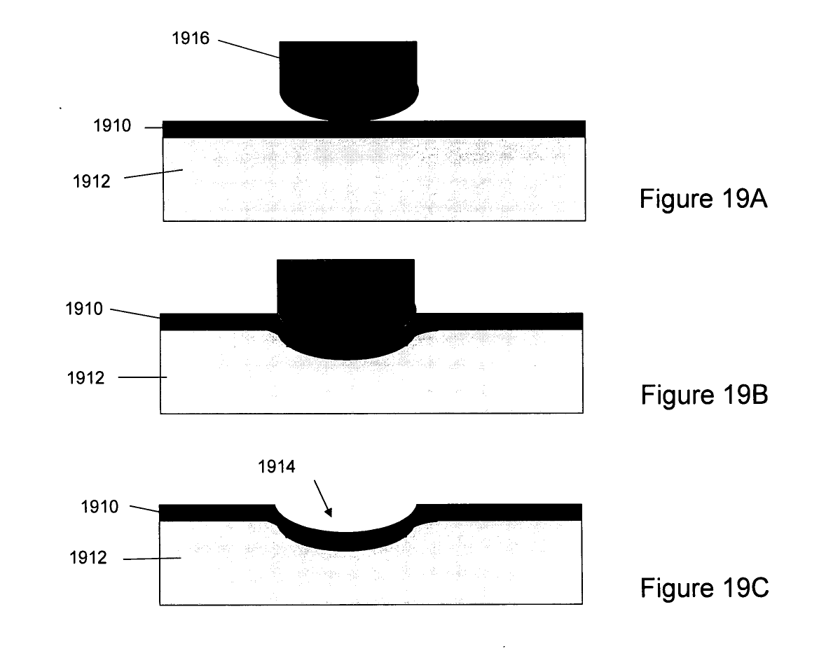

Referring now to FIGS. 19A-19C, a method is shown to produce a layer 1910 on a substrate 1912 having a shaped region 1914 formed thereon, further wherein the substrate 1912 conforms to the shape or shaped region 1914 formed in the layer 1910. In this embodiment, the substrate 1912 is formed of suitable material that may deform upon application of pressure by a shaping tool 1916 (wherein the pressure is transmitted through the layer 1910. For example, the substrate by similar in concept to traditional float glass techniques. Suitable materials for the substrate 1912 include but are not limited to molten lead based materials, wax materials, or other photo-polymerizable materials.

Upon application of the shaping tool 1916 to the layer 1910 in conditions where the substrate 1912 is in a liquid state, mixed solid-liquid state, or very pliable solid, the layer 1910 will bend and the force will be transmitted to the substrate 1912. Thus, the shape of substrate 1912 will conform to the shape 1914 of layer 1910 (i.e., the inverse shape of the shaping portion of the shaping tool 1916). Note during shaping, other mechanical sub-systems may be in place to perform certain functions, for example, holding/clamping the ends of the layer 1910 in place to allow some flexing during the shaping process.

Various shapes may be formed according to the method shown in FIG. 19, for example, concave shapes, grooves, channels, and the like. These shapes may be used in a variety of applications, including but not limited to optics (in the form of lenses, mirrors, x-ray lenses or mirrors (e.g., in multilayer)), micro- or nano-fluids, micro- or nano-electromechanical systems, or micro- or nano-opto-mechanical systems.

In one embodiment, the shape, for example, a concave shape as shown in FIG. 19, may be used in certain optics applications. For example, a novel x-ray structure may be created using the shape 1914 in a crystalline form, e.g., of one or more graphene layers or a highly oriented pyrolytic graphite. This may replace, in a very cost effective manner, ellipsoidally bent crystals, toroidally bent crystals or other bent crystals for this purpose, for example, as described in Uschmann I, et al.¹². ¹²Uschmann I, Nothelle U, Forster E, Arkadiev V, Langhoff N, Antonov A, Grigorieva I, Steinkopf R, Gebhardt A., Appl Opt. 2005 Aug. 20; 44(24):5069-75.“High efficiency, high quality x-ray optic based on ellipsoidally bent highly oriented pyrolytic graphite crystal for ultrafast x-ray diffraction experiments,” Institut for Optik und Quantenelektronik, Friedrich-Schiller-Universitat Jena, Max-Wien-Platz 1, D-07743 Jena, Germany. “By the use of a thin highly oriented pyrolytic graphite crystal (HOPG) bent to a high-performance ellipsoidal shape it was possible to focus monochromatic x-rays of 4.5 keV photon energy with an efficiency of 0.0033, which is 30 times larger than for previously used bent crystals. Isotropic Ti K alpha radiation of a 150 microm source was focused onto a 450 microm spot. The size of the focal spot can be explained by broadening due to the mosaic crystal rocking curve. The rocking curve width (FWHM) of the thin graphite foil was determined to 0.11 degrees. The estimated temporal broadening of an ultrashort K alpha pulse by the crystal is not larger than 300 fs. These properties make the x-ray optic very attractive for ultrafast time-resolved x-ray measurements.”

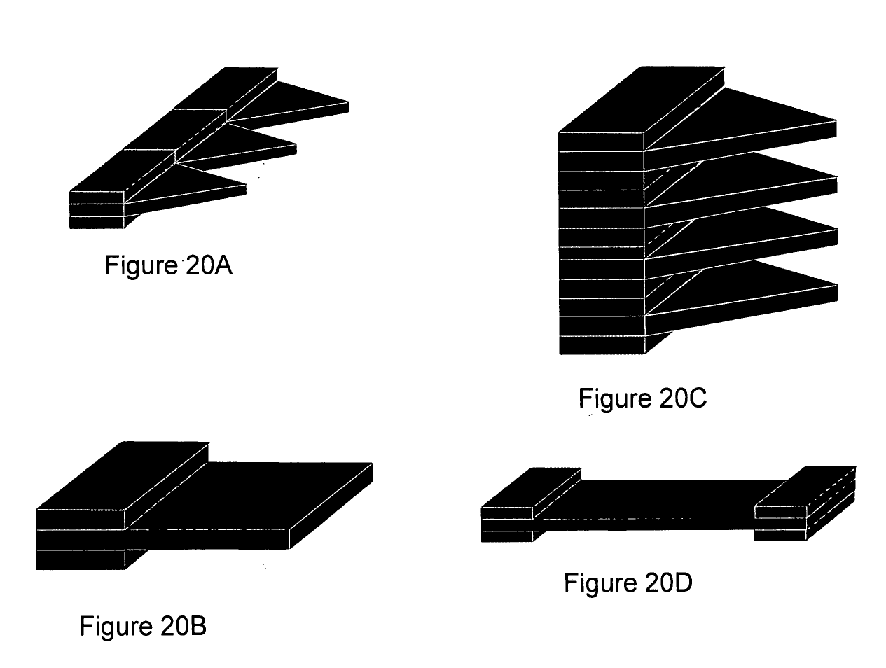

In various embodiments of the present invention, it is possible to form many different useful structures a predetermined number of atomic layers cut to virtually any desired shape. For example, and referring now to FIGS. 20A-20D, various exemplary nanotools are shown, including a serial probe structure (FIG. 20A), e.g., for a) applying energy across several specimens, and/or b) measuring interaction; Cantilever structure (FIG. 20B) any of above as probe, MEMs element, microfluidics element, piezoelectric, piezomagnetic; stacked probe structure (FIG. 20C), e.g., a) for applying energy across several specimens, and/or b) measuring interaction, or alternating or sequence a), b); applying scanning field across specimen; and stretched structure (FIG. 20D) such as a MEMs element, microfluidics element, piezoelectric element, or piezomagnetic element.

The materials of construction for the above described nanotools may be homogeneous or heterogeneous. If certain portions are different from the carbon based materials described herein, other known cutting techniques may be used to form the desired shape, and various stacking and alignment technologies may be employed for stacking, including but not limited to those described by applicant in U.S. Pat. No. 7,045,878 and U.S. patent application Ser. No. 10/970,814 filed on Oct. 21, 2004 and manipulation and formation of vertically integrated devices of such films taught in applicant's U.S. Pat. No. 7,033,910, U.S. patent application Ser. No. 11/406,848, U.S. Pat. No. 6,875,671, U.S. patent application Ser. No. 11/020,753, U.S. patent application Ser. No. 10/719,663, U.S. Pat. No. 6,956,268, and U.S. patent application Ser. No. 10/793,653, all of which are incorporated by reference herein.

The nanostrucutres of FIGS. 20A-20B, and other nanostructures, may be formed by starting with stack of materials having desired layer arrangement and cutting with various ECT's as described herein. Further, nanostrucutres of FIGS. 20A-20B, and other nanostructures, may be formed by cutting shapes and using nano-manipulating tools or self assembly techniques to form the desired structures. Still further, nanostrucutres of FIGS. 20A-20B, and other nanostructures, may be formed by a combination of cutting stacks and individual shapes and also using nano-manipulating tools or self assembly techniques.

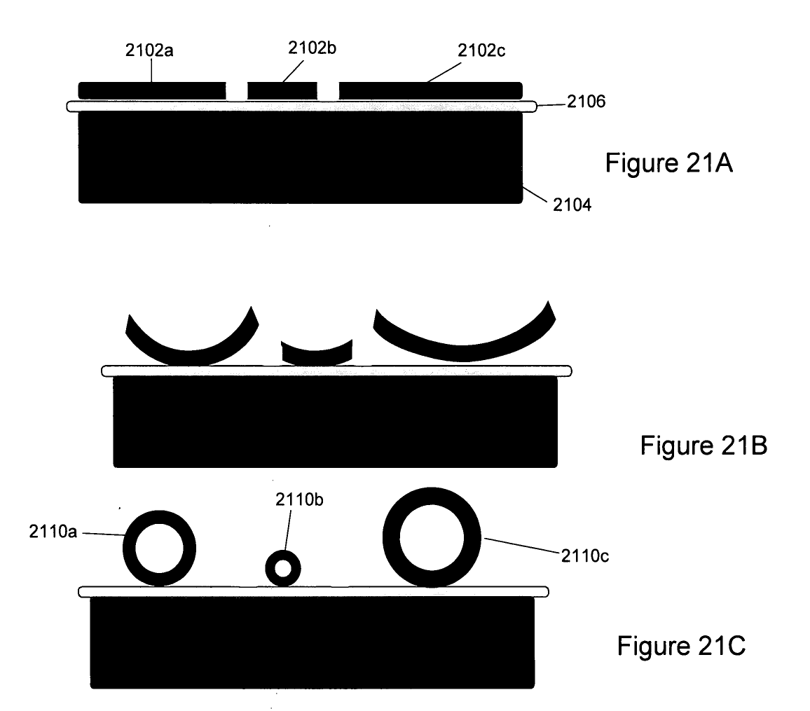

Referring now to FIGS. 21A-21C, steps are shown to form precision nanotubes according to certain aspects of the present invention. As shown therein, various dimension structures 2102a, 2102b and 2102c of a predetermined number of atomic layers may be applied to a substrate 2104, optionally with an intermediate layer 2106 therebetween. In certain embodiments, the intermediate layer 2106 or the top surface of the substrate 2104 have properties that will allow one to a) be able to lay the structures 2102a, 2102b and/or 2102c flat, and then b) allow the ends to curl together to form nanotubes. The structures 2102a, 2102b and/or 2102c may be applied on the substrate or intermediate layer with a suitable handler device, for example that is removably attached, e.g., with a removable adhesive, or using vacuum pressure, for example, as described in applicants co-pending U.S. patent application Ser. No. 10/017,186 filed on Dec. 7, 2001 entitled “Device And Method For Handling Fragile Objects, And Manufacturing Method Thereof”, which is incorporated by reference herein.

In either case, to induce curling as described below, strain exists between the structures 2102a, 2102b and 2102c and either the intermediate layer 2106 or the top surface of the substrate 2104. Such strain may be by virtue of lattice mismatches. In certain embodiments, the lattice mismatches between the structures 2102a, 2102b and 2102c and either the intermediate layer 2106 or the top surface of the substrate 2104 may be tailored such that upon application of certain temperature and/or pressure conditions, the mismatch is increases such that the structures 2102a, 2102b and 2102c curl as shown in FIG. 21B (curled structures 2108a, 2108b and 2108c).

In certain preferred embodiments, the edges connect thereby forming nanotubes as shown by structures 2110a, 2110b and 2110c in FIG. 21C.

Note that the predetermined number of layers, which may be as few as one layer and as many as desired depending on the number of walls desired, may be formed according to the methods described herein. Further, the predetermined number of layers may be formed into any desired shape or dimension, thus it is also possible to form precise dimensioned and configuration nanotubes.

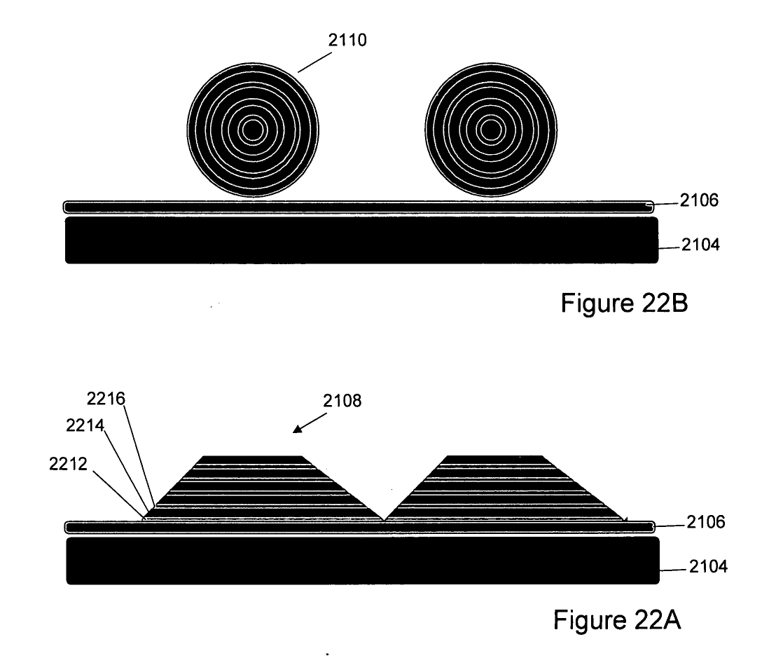

Referring now to FIGS. 22A-22B, steps are shown to form precision nanotubes having one or more coaxial tubes therein according to certain embodiments of the present invention. The composite stack may be, for example, as described above with reference to FIGS. 7, 8A and/or 8B. Note that one of the materials in the composite stack may be one or more atomic layers derived from a lamellar material as described herein, and one or more other materials may comprise, for example, materials selected from the group consisting of oxides, superconductors, metals, semiconductors, magnetic materials, hydrides, GdMg, WO3, MoO3, LiCoO2, and other lamellar materials. Note that as used herein, “coaxial” may refer to two or more layers sharing a common center.

Notably, it is possible to use the teaching herein for forming nanotubes of virtually any desired structure (cylindrical, conical, extruded elliptical structure), dimension (diameter and length) and composition.

Further, it is possible to form heterogeneous composites including the nanotubes herein and the method described. For example, in certain embodiments, materials may be formed in a coaxial fashion as shown in FIGS. 22A-22B. In these embodiments, the material layers 2214, 2216 are formed in laminar or lamellar manner with respect to layer 2212.

In further embodiments, heterogeneous composites may be formed by addition of a species to be encapsulated generally atop the structures 2102 prior to or during curling to form nanotubes having encapsulated material therein. In these embodiments, the material to be encapsulated is generally placed on the underlying structures 2102.

Various encapsulation techniques in the context of random size graphene oxide sheets are described in T. Cassagneau, J. H. Fendler, J. Phys. Chem. B, 103, 1789-1793 (1999), Preparation and Layer-by-Layer Self-assembly of Silver Nanoparticles Capped by Graphite Oxide Nanosheets, which is incorporated by reference herein.

While preferred embodiments have been shown and described, various modifications and substitutions may be made thereto without departing from the spirit and scope of the invention. Accordingly, it is to be understood that embodiments of the present invention has been described by way of illustrations and not limitation.

What is claimed is:

1. A method to form a nanostructure comprising
providing a structure formed in predetermined configuration on a substrate, wherein a lattice mismatch exists between the structure and the substrate, the lattice mismatch; allowing the structure to curl into a nanostructure.

2. The method as in claim 1, wherein the structure includes a predetermined number of layers.

3. The method as in claim 3, wherein the predetermined number of layers include atomic layers.

4. The method as in claim 1, wherein the substrate includes an intermediate layer, the structure being supported on the intermediate layer and the lattice mismatch existing between the structure and the intermediate layer.

5. The method as in claim 1, wherein allowing to curl includes inducing curling.

6. The method as in claim 5, wherein inducing curling comprises exposing the structure on the substrate to elevated temperature and/or pressure conditions.

7. The method as in claim 1, wherein edge portions of the structure connect to form nanotubes.

8. The method as in claim 2, wherein the predetermined number of layers consists of one layer.

9. The method as in claim 2, wherein the predetermined number of layers comprises less than 5 layers.

10. The method as in claim 2, wherein the predetermined number of layers comprises less than 10 layers.

11. The method as in claim 2, wherein the predetermined number of layers comprises less than 50 layers.

12. The method as in claim 2, wherein the predetermined number of layers comprises less than 100 layers.

13. The method as in claim 1, wherein the configuration of the structure determines final dimensions of the nanostructure.

14. The method as in claim 7, wherein the configuration of the structure determines final dimensions of the nanotube.

15. The method as in claim 1, wherein the structure further comprises a material thereon, wherein the nanostructure is a heterogeneous nanostructure.

16. The method as in claim 15, wherein the material on the structure is a layer.

17. The method as in claim 7, wherein the structure further comprises a material thereon, wherein the nanotube is a heterogeneous nanotube.

18. The method as in claim 17, wherein the material on the structure is a layer.

19. The method as in claim 18, wherein the nanotube is formed into a coaxial configuration.

20. The method as in claim 17, wherein the material on the structure encapsulated to form an encapsulated nanotube.

21. A system for forming a nanostructure comprising:
a substrate having
a surface with a first lattice structure, or
a layer on the substrate with a first lattice structure;
a source of nanoscale structures having known configurations and second lattice structures;
a handler for selecting one or more nanoscale structures having known configurations and applying the one or more nanoscale structures to the surface or the layer with the first lattice structure,
wherein the first and second lattice structures are mismatched to allow curling of the nanoscale structures.

22. The system as in claim 21, further comprising a heat source and/or a pressure source to induce curling of the nanoscale structures.
